(19) United States
(12) Patent Application Publication
(10) Pub. No.: US 2026/0225617 A1
(43) Pub. Date: Aug. 6, 2026

(54) VEHICLE DRIVING ASSISTANCE DEVICE, VEHICLE DRIVING ASSISTANCE METHOD, AND VEHICLE DRIVING ASSISTANCE PROGRAM

(71) Applicant: TOYOTA JIDOSHA KABUSHIKI KAISHA, Toyota-shi, Aichi-ken (JP)

(72) Inventors: Hideki KAMATANI, Nagoya-shi, Aichi-ken (JP); Takahiro NARITA, Chuo-ku, Tokyo (JP)

(73) Assignee: TOYOTA JIDOSHA KABUSHIKI KAISHA, Toyota-shi, Aichi-ken (JP)

(21) Appl. No.: 19/149,944

(22) PCT Filed: Nov. 30, 2023
(86) PCT No.: PCT/JP2023/042914

§ 371 Date: Jul. 22, 2025

(30) Foreign Application Priority Data
Jan. 31, 2023 (JP) 2023-012908

(51) Int. Cl. B60W 60/00; B60W 30/14; B60W 50/02; B60W 50/029; B60W 50/08

(52) U.S. Cl. CPC B60W 60/0015; B60W 30/143; B60W 50/0205; B60W 50/029; B60W 50/082

(57) ABSTRACT

A vehicle driving assistance device for reducing energy depending on a drive mode executes an autonomous driving control of an own vehicle in a first motion mode in which the own vehicle's control value is increased/decreased within a control range by selectively executing a power control in a first state wherein power generation loss or power transmission loss from the power device to driving wheels is reduced, and in a second state in which the power device is mechanically or electrically connected for powering driving wheels. During the first motion mode, when a drive mode is a first drive mode in which the power other than from a power storage device can be used, the vehicle driving assistance device sets the set control range to a wider range than when the drive mode is in a second drive mode in which only power by the electric power is used.

### TECHNICAL FIELD

The present invention relates to a vehicle driving assistance device, a vehicle driving assistance method, and a vehicle driving assistance program.

### BACKGROUND ART

A vehicle driving assistance device is known which executes an autonomous driving control to drive an own vehicle by autonomously controlling an operation of a power device of the own vehicle such that a vehicle speed of the own vehicle increases or decreases within a set vehicle speed range, or an inter-vehicle distance between the own vehicle and a preceding vehicle increases or decreases within a set inter-vehicle distance range (see, for example, Patent Document 1). The vehicle driving assistance device reduces an amount (or a consumed energy amount) of energy consumed in the power device by driving the own vehicle by the autonomous driving control.

### CITATION LIST

### Patent Literature

PLT 1: JP 2022-95320 A

### SUMMARY OF INVENTION

As a means for realizing the above-mentioned autonomous driving control, there is a means for causing the own vehicle to coast when the vehicle speed of the own vehicle reaches an upper limit of the set vehicle speed range, and for powering the own vehicle when the vehicle speed of the own vehicle reaches a lower limit of the set vehicle speed range, and there is also a means for causing the own vehicle to coast when the inter-vehicle distance between the own vehicle and the preceding vehicle reaches a lower limit of the set inter-vehicle distance range, and for powering the own vehicle when the inter-vehicle distance between the own vehicle and the preceding vehicle reaches an upper limit of the set inter-vehicle distance range.

In the case that the power device includes an internal combustion engine and an electric motor, the own vehicle can be selectively powered in a hybrid drive mode, in which the own vehicle is powered by power output from at least one of the internal combustion engine and the electric motor, and in a motor drive mode, in which the own vehicle is powered only by power output from the electric motor.

In the case that a powered driving in the hybrid drive mode and a powered driving in the motor drive mode are selectively performed during the execution of the autonomous driving control, an effect of reducing the consumed energy amount achieved by the autonomous driving control by the powering driving in the hybrid drive mode is not the same as the effect of reducing the consumed energy amount achieved by the autonomous driving control by the powering driving in the motor drive mode.

An object of the present invention is to provide a vehicle driving assistance device, a vehicle driving assistance method, and a vehicle driving assistance program which can achieve a certain effect of reducing the consumed energy amount depending on the drive mode.

A vehicle driving assistance device according to the present invention, comprises a control device configured to execute an autonomous driving control of autonomously driving an own vehicle in a first motion mode in which a control value of the own vehicle is increased or decreased within a set control range by selectively executing a power control in a first state in which a power generation loss in a power device or a power transmission loss from the power device to driving wheels is reduced, and a power control in a second state in which the power device is mechanically or electrically connected to the driving wheels and power is applied to the driving wheels. The control device is configured to set the set control range to a wider range when a drive mode is a first drive mode in which the power other than the power generated by electric power of a power storage device can be used than when the drive mode is a second drive mode in which only power generated by the electric power is used during the execution of the autonomous driving control in the first motion mode.

In the case where the own vehicle is driven autonomously by the autonomous driving control in the first motion mode, while the own vehicle is driven autonomously in the first drive mode, if the set control range is set to a wide range, the effect of reducing the consumed energy amount is generally greater. However, even if the set control range is set to a wide range, when the own vehicle is driven autonomously in the second drive mode, the effect of reducing the consumed energy amount is not so great.

According to the vehicle driving assistance device of the present invention, in the case where the own vehicle is driven autonomously by the autonomous driving control in the first motion mode, while the drive mode is the first drive mode, the set control range is set to a wider range than when the drive mode is the second drive mode. Therefore, a certain effect of reducing the consumed energy amount can be achieved depending on the drive mode.

It should be noted that in the vehicle driving assistance device according to the present invention, the set control range is changeable, for example, by a setting operation by a driver of the own vehicle while the own vehicle is driven autonomously by the autonomous driving control in the first drive mode.

According to the vehicle driving assistance device of the present invention, the driver can set the set control range as desired.

Furthermore, in the vehicle driving assistance device according to the present invention, while the own vehicle is driven autonomously by the autonomous driving control in the first drive mode, when an abnormality occurs in a following vehicle detection device which detects a following vehicle, the control device may be configured to set the set control range to a narrower range than when the following vehicle detection device is normal.

In the case where the own vehicle is driven autonomously by the autonomous driving control in the first motion mode, while the following vehicle is present, if the vehicle speed of the own vehicle increases or decreases excessively or a distance between the own vehicle and a preceding vehicle increases or decreases excessively, the following vehicle increases or decreases its speed excessively, which may hinder smooth traffic of surrounding vehicles including the following vehicle. Therefore, in order to maintain the smooth traffic of the surrounding vehicles, in the case where the own vehicle is driven autonomously by the autonomous driving control in the first motion mode, while the following vehicle is present, it is desirable to drive the own vehicle autonomously by the autonomous driving control in the first motion mode taking into account the presence of the following vehicle. However, in order to do so, it is necessary to detect the following vehicle by the following vehicle detection device, but if the following vehicle cannot be detected due to an abnormality occurring in the following vehicle detection device, it is not possible to execute the autonomous driving control taking into account the presence of the following vehicle, and therefore it is not possible to drive the own vehicle autonomously by the autonomous driving control in the first motion mode so as to maintain the smooth traffic of the surrounding vehicles.

According to the vehicle driving assistance device of the present invention, when an abnormality occurs in the following vehicle detection device, the set control range is set to a narrower range than when the following vehicle detection device is normal. This maintains the control value such as the vehicle speed of the own vehicle and the distance between the own vehicle and the preceding vehicle within a narrow range, thereby preventing excessively large increases and decreases in the vehicle speed of the own vehicle and in the distance between the own vehicle and the preceding vehicle. Therefore, even when the following vehicle cannot be detected, the own vehicle can be driven autonomously by the autonomous driving control in the first motion mode without interfering with the smooth traffic of the surrounding vehicles.

Furthermore, in the vehicle driving assistance device according to the present invention, the control device may be configured to be able to execute the autonomous driving control in a second motion mode in which the control value is maintained at a set control value. In this case, during the execution of the autonomous driving control in the first motion mode, the control device may be configured to switch a mode of the autonomous driving control from the first motion mode to the second motion mode when a motion mode switching condition that the following vehicle detection device is normal, the following vehicle is detected, and a distance between the following vehicle and the own vehicle is equal to or less than a predetermined distance, or a time required for the own vehicle to travel the distance between the following vehicle and the own vehicle is equal to or less than a predetermined time, is satisfied.

In the case where the own vehicle is driven autonomously by the autonomous driving control in the first motion mode, while the following vehicle is present, if the vehicle speed of the own vehicle increases or decreases excessively or the distance between the own vehicle and the preceding vehicle increases or decreases excessively, the following vehicle increases or decreases its vehicle speed excessively, which may hinder the smooth traffic of the surrounding vehicles including the following vehicle.

According to the vehicle driving assistance device of the present invention, when the following vehicle is relatively close to the own vehicle, that is, when the motion mode switching condition is satisfied, the mode of the autonomous driving control is switched from the first motion mode to the second motion mode. This maintains the vehicle speed of the own vehicle constant, and also maintains the distance between the own vehicle and the preceding vehicle constant. Therefore, even when the following vehicle is relatively close to the own vehicle, the own vehicle can be driven autonomously such that the smooth traffic of the surrounding vehicles is maintained.

Furthermore, in the vehicle driving assistance device according to the present invention, when the autonomous driving control is executed in the second drive mode, the set control range is set to, for example, a narrower range than when the autonomous driving control is executed in the first drive mode. In this case, during the execution of the autonomous driving control in the second drive mode, the control device may be configured not to change the set control range even when an abnormality occurs in the following vehicle detection device.

According to the vehicle driving assistance device of the present invention, when the own vehicle is driven autonomously by the autonomous driving control in the second drive mode, the set control range is set to a relatively narrow range. Therefore, even in a situation where the following vehicle cannot be detected due to an abnormality occurring in the following vehicle detection device, the own vehicle can continue to drive autonomously by the autonomous driving control without changing the set control range, and the vehicle speed of the own vehicle does not increase or decrease excessively, and the distance between the own vehicle and the preceding vehicle does not increase or decrease excessively, and therefore the following vehicle does not increase or decrease its vehicle speed excessively. Therefore, there is little possibility that the smooth traffic of the surrounding vehicles is hindered. Therefore, the own vehicle can be driven autonomously by the autonomous driving control such that the smooth traffic of the surrounding vehicles is maintained without changing the set control range.

Furthermore, in the vehicle driving assistance device according to the present invention, the control device may be configured to suspend the autonomous driving control in the first motion mode and execute the autonomous driving control by the power control in the first state when a first condition is satisfied. In this case, the first condition is set to, for example, a condition which is likely to be satisfied while the own vehicle travels on a downhill road, and is more likely to be satisfied when the own vehicle is driven autonomously by the autonomous driving control in the first drive mode than when the own vehicle is driven autonomously by the autonomous driving control in the second drive mode.

Even if the own vehicle is driven autonomously in the first state, while the own vehicle travels on the downhill road, the vehicle speed of the own vehicle tends to increase, so there is no need to drive the own vehicle autonomously in the second state to increase the vehicle speed of the own vehicle. Therefore, while the own vehicle travels on the downhill road, when the own vehicle is driven autonomously in the first state, the effect of reducing the consumed energy amount is greater than when the own vehicle is driven autonomously in the second state. Furthermore, when the own vehicle is driven autonomously in the first drive mode in the first motion mode, the effect of reducing the consumed energy amount by not driving the own vehicle autonomously in the second state is greater than when the own vehicle is driven autonomously in the second drive mode in the first motion mode.

According to the vehicle driving assistance device of the present invention, the first condition is set to a condition which is likely to be satisfied while the own vehicle travels on the downhill road. That is, the first condition is set to a condition under which the autonomous driving control in the first motion mode is likely to be suspended and the autonomous driving control in the first state is likely to be executed while the own vehicle travels on the downhill road. Moreover, the first condition is set to a condition which is less likely to be satisfied when the own vehicle is driven autonomously by the autonomous driving control in the second drive mode than when the own vehicle is driven autonomously by the autonomous driving control in the first drive mode. That is, the first condition is set to a condition under which the autonomous driving control in the first motion mode is less likely to be suspended and the autonomous driving control in the first state is less likely to be executed when the own vehicle is driven autonomously by the autonomous driving control in the second drive mode. Therefore, a great effect of reducing the consumed energy amount can be achieved.

Furthermore, in the vehicle driving assistance device according to the present invention, the control device may be configured to be able to execute the autonomous driving control in a constant speed mode in which a vehicle speed of the own vehicle is maintained at a set vehicle speed. In this case, the control device may be configured to suspend the autonomous driving control in the first motion mode and execute the autonomous driving control in the constant speed mode when a second condition is satisfied. In addition, in this case, the second condition is, for example, a condition which is likely to be satisfied while the own vehicle travels on an uphill road or while the own vehicle travels at a vehicle speed equal to or higher than a predetermined vehicle speed, and is more likely to be satisfied when the own vehicle is driven autonomously by the autonomous driving control in the first drive mode than when the own vehicle is driven autonomously by the autonomous driving control in the second drive mode.

While the own vehicle travels on the uphill road or while the own vehicle travels at high speed, the vehicle speed of the own vehicle may be significantly reduced if the own vehicle is autonomously driven in the first state, and the vehicle speed of the own vehicle may not be increased appropriately if the own vehicle is autonomously driven in the second state. Therefore, while the own vehicle travels on the uphill road or while the own vehicle travels at high speed, the effect of reducing the consumed energy amount is reduced if the own vehicle is driven autonomously by the autonomous driving control in the first motion mode.

Furthermore, when the own vehicle is driven autonomously by the autonomous driving control in the first drive mode, the set control range is set to a wider range than when the own vehicle is driven autonomously by the autonomous driving control in the second drive mode, and thus while the own vehicle travels on the uphill road or while the own vehicle travels at high speed, the effect of reducing the consumed energy amount is reduced if the own vehicle is driven autonomously by the autonomous driving control in the first drive mode and the first motion mode.

According to the vehicle driving assistance device of the present invention, the second condition is set to a condition which is likely to be satisfied while the own vehicle travels on the uphill road or while the own vehicle travels at a vehicle speed equal to or greater than a predetermined vehicle speed, and is more likely to be satisfied when the own vehicle is driven autonomously by the autonomous driving control in the first drive mode than when the own vehicle is driven autonomously by the autonomous driving control in the second drive mode. In addition, when the second condition is satisfied, the autonomous driving control in the first motion mode is suspended and the autonomous driving control in the constant speed mode is executed. That is, in the case where the own vehicle travels on the uphill road or the own vehicle travels at a vehicle speed equal to or higher than the predetermined vehicle speed, while the own vehicle is driven autonomously by the autonomous driving control in the first drive mode and the first motion mode, the autonomous driving control in the first motion mode is likely to be suspended and the autonomous driving control in the constant speed mode is likely to be executed. This makes it possible to ensure a certain effect of reducing the consumed energy amount.

Furthermore, a vehicle driving assistance method according to the present invention is a method for executing an autonomous driving control of autonomously driving an own vehicle in a first motion mode in which a control value of the own vehicle is increased or decreased within a set control range by selectively executing a power control in a first state in which a power generation loss in a power device or a power transmission loss from the power device to driving wheels is reduced, and a power control in a second state in which the power device is mechanically or electrically connected to the driving wheels and power is applied to the driving wheels. The vehicle driving assistance method according to the present invention comprises a step of setting the set control range to a wider range when a drive mode is a first drive mode in which the power other than the power generated by electric power of a power storage device can be used than when the drive mode is a second drive mode in which only power generated by the electric power is used during the execution of the autonomous driving control in the first motion mode.

According to the vehicle driving assistance method of the present invention, a certain effect of reducing the consumed energy amount depending on the drive mode can be achieved for the same reason as described above.

Furthermore, a vehicle driving assistance program according to the present invention is a program which executes an autonomous driving control of autonomously driving an own vehicle in a first motion mode in which a control value of the own vehicle is increased or decreased within a set control range by selectively executing a power control in a first state in which a power generation loss in a power device or a power transmission loss from the power device to driving wheels is reduced, and a power control in a second state in which the power device is mechanically or electrically connected to the driving wheels and power is applied to the driving wheels. The vehicle driving assistance program is configured to set the set control range to a wider range when a drive mode is a first drive mode in which the power other than the power generated by electric power of a power storage device can be used than when the drive mode is a second drive mode in which only power generated by the electric power is used during the execution of the autonomous driving control in the first motion mode.

According to the vehicle driving assistance program of the present invention, a certain effect of reducing the consumed energy amount depending on the drive mode can be achieved for the same reason as described above.

The components of the present invention are not limited to the embodiments of the present invention described below with reference to the drawings. Other objects, other features, and associated advantages of the present invention will be easily understood from the description of the embodiments of the present invention.

### BRIEF DESCRIPTION OF DRAWINGS

FIG. 1 is a diagram showing a vehicle driving assistance device according to an embodiment of the present invention.

FIG. 2A is a diagram showing a scene where a preceding vehicle is present in front of an own vehicle.

FIG. 2B is a diagram showing a scene where no preceding vehicle is present in front of the own vehicle.

FIG. 3A is a diagram showing a scene where no preceding vehicle is present ahead of the own vehicle, but a following vehicle is present behind the own vehicle.

FIG. 3B is a diagram showing a scene where the preceding vehicle is present ahead of the own vehicle, and the following vehicle is present behind the own vehicle.

FIG. 4 is a flowchart showing a routine executed by the vehicle driving assistance device according to the embodiment of the present invention.

FIG. 5 is a flowchart showing a routine executed by the vehicle driving assistance device according to the embodiment of the present invention.

FIG. 6 is a flowchart showing a routine executed by the vehicle driving assistance device according to the embodiment of the present invention.

FIG. 7 is a flowchart showing a routine executed by the vehicle driving assistance device according to the embodiment of the present invention.

FIG. 8 is a time chart showing change in a road gradient and a vehicle speed when an economy autonomous driving control is terminated and a normal vehicle speed control is executed.

FIG. 9 is a time chart showing the change in the road gradient and the vehicle speed when the normal vehicle speed control is executed after the economy autonomous driving control is terminated and a coasting control is executed.

FIG. 10 is a flowchart showing a routine executed by the vehicle driving assistance device according to the embodiment of the present invention.

FIG. 11 is a flowchart showing a routine executed by the vehicle driving assistance device according to the embodiment of the present invention.

FIG. 12 is a flowchart showing a routine executed by the vehicle driving assistance device according to the embodiment of the present invention.

FIG. 13 is a flowchart showing a routine executed by the vehicle driving assistance device according to the embodiment of the present invention.

### DESCRIPTION OF EMBODIMENTS

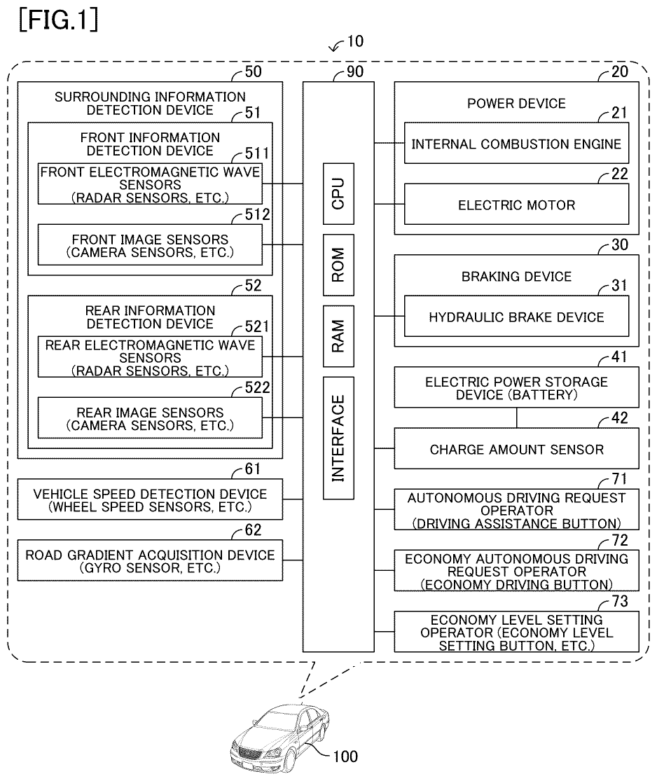

Below, a vehicle driving assistance device, a vehicle driving assistance method, and a vehicle driving assistance program according to an embodiment of the present invention will be described with reference to the drawings. FIG. 1 shows the vehicle driving assistance device 10. The vehicle driving assistance device 10 is mounted on an own vehicle 100. Below, the vehicle driving assistance device 10 will be described using an example in which an operator of the own vehicle 100 is a person who rides in the own vehicle 100 and drives the own vehicle 100 (i.e., a driver of the own vehicle 100).

However, the operator of the own vehicle 100 may also be a person who drives the own vehicle 100 remotely without riding in the own vehicle 100 (i.e., a remote operator of the own vehicle 100). When the operator of the own vehicle 100 is the remote operator, the vehicle driving assistance device 10 is mounted on the own vehicle 100 and on a remote operation facility installed outside the own vehicle 100 to remotely drive the own vehicle 100, and functions of the vehicle driving assistance device 10 described below are shared between the vehicle driving assistance device 10 mounted on the own vehicle 100 and the vehicle driving assistance device 10 mounted on the remote operation facility.

As shown in FIG. 1, the vehicle driving assistance device 10 includes an ECU (i.e., an electronic control device) 90 as a control device. The ECU 90 includes a microcomputer as a main component. The microcomputer includes a CPU, a storage medium such as a ROM, a RAM, and a non-volatile memory, and an interface. The CPU is configured to realize various functions by executing instructions, programs, or routines stored in the storage medium. In particular, in this embodiment, the vehicle driving assistance device 10 stores programs which realizes various controls executed by the vehicle driving assistance device 10 in the storage medium.

It should be noted that the vehicle driving assistance device 10 may be configured to update the programs stored in the storage medium by wireless communication (for example, Internet communication) with external devices.

As shown in FIG. 1, the own vehicle 100 is equipped with a power device 20 and a braking device 30. The power device 20 is a device which generates power to be applied to the own vehicle 100 (particularly, driven wheels of the own vehicle 100), and in this embodiment, includes an internal combustion engine 21 and an electric motor 22. The braking device 30 is a device which applies braking force to the own vehicle 100 (particularly, wheels of the own vehicle 100), and in this embodiment, includes a hydraulic brake device 31. The internal combustion engine 21, the electric motor 22, and the hydraulic brake device 31 are electrically connected to the ECU 90. The vehicle driving assistance device 10 can control operations of the internal combustion engine 21, the electric motor 22, and the hydraulic brake device 31.

Furthermore, the own vehicle 100 is equipped with an electric power storage device 41 such as a battery and a charge amount sensor 42. The electric motor 22 is operated by electric power stored in the electric power storage device 41. The electric motor 22 also generates electricity by the power output from the internal combustion engine 21 and charges the generated electricity to the electric power storage device 41. The charge amount sensor 42 is a sensor which detects an amount of electric power charged in the electric power storage device 41. The charge amount sensor 42 is electrically connected to the ECU 90. The vehicle driving assistance device 10 detects the amount of electric power charged in the electric power storage device 41 by the charge amount sensor 42.

Furthermore, the own vehicle 100 is equipped with a surrounding information detection device 50. The surrounding information detection device 50 is a device which acquires information on the surroundings of the own vehicle 100 as surrounding information detection information IS. In this embodiment, the surrounding information detection device 50 includes a front information detection device 51 and a rear information detection device 52.

The front information detection device 51 includes front electromagnetic wave sensors 511 such as radar sensors and front image sensors 512 such as camera sensors. The front electromagnetic wave sensors 511 and the front image sensors 512 are electrically connected to the ECU 90. The vehicle driving assistance device 10 acquires data (or forward object information IF_O) on objects ahead of the own vehicle 100 as forward detection information IF by the front electromagnetic wave sensors 511. The vehicle driving assistance device 10 also acquires image data (or forward image information IF_C) ahead of the own vehicle 100 as the forward detection information IF by the front image sensors 512.

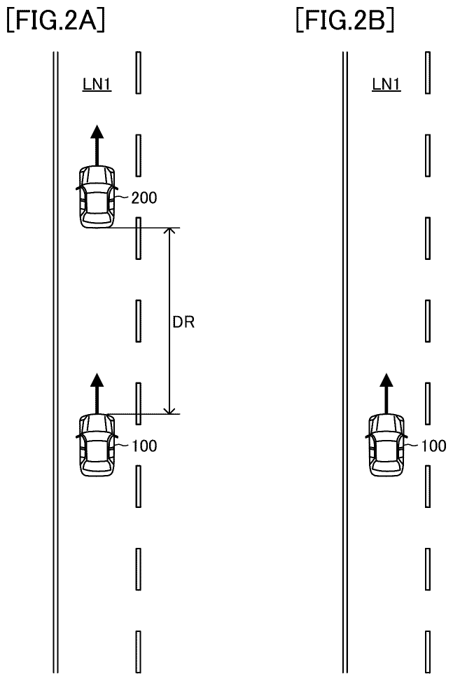

The vehicle driving assistance device 10 detects a preceding vehicle 200 based on the forward object information IF_O and/or the forward image information IF_C, and further acquires a preceding vehicle distance DF. As shown in FIG. 2A, the preceding vehicle 200 is another vehicle travelling in front of the own vehicle 100 within a predetermined distance from the own vehicle 100, and travelling in an own vehicle travelling lane LN1. The preceding vehicle distance DF is a distance (or an inter-vehicle distance) between the own vehicle 100 and the preceding vehicle 200.

The rear information detection device 52 includes rear electromagnetic wave sensors 521 such as radar sensors and rear image sensors 522 such as camera sensors. The rear electromagnetic wave sensors 521 and the rear image sensors 522 are electrically connected to the ECU 90. The vehicle driving assistance device 10 acquires data (or rear object information IR_O) on objects behind the own vehicle 100 as rear detection information IR by the rear electromagnetic wave sensors 521. The vehicle driving assistance device 10 also acquires image data (or rear image information IR_C) behind the own vehicle 100 as the rear detection information IR by the rear image sensors 522.

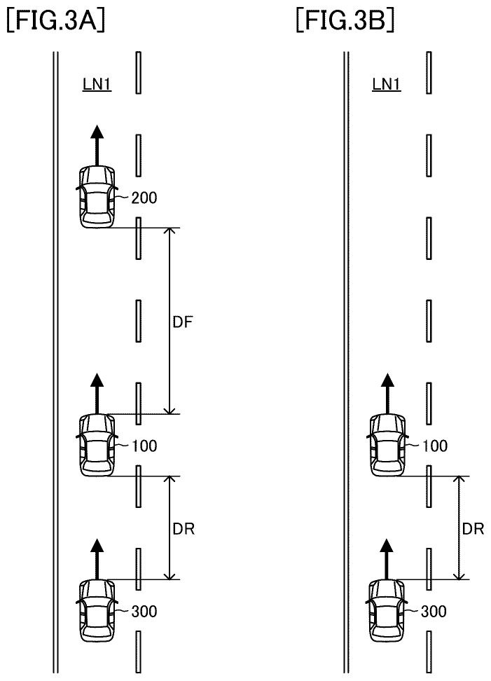

The vehicle driving assistance device 10 detects a following vehicle 300 based on the rear object information IR_O and/or the rear image information IR_C, and further acquires a following vehicle distance DR. As shown in FIG. 3A and FIG. 3B, the following vehicle 300 is another vehicle travelling behind the own vehicle 100 within a predetermined distance from the own vehicle 100, and travelling in the own vehicle travelling lane LN1. The following vehicle distance DR is a distance (or an inter-vehicle distance) between the own vehicle 100 and the following vehicle 300.

### <Summary of Operation of Vehicle Driving Assistance Device>

Next, a summary of an operation of the vehicle driving assistance device 10 will be described.

The vehicle driving assistance device 10 is configured to selectively execute a power control in a first state in which a power generation loss in the power device 20 or a power transmission loss from the power device 20 to the driven wheels is reduced (for example, a coasting control described later), and the power control in a second state in which the power device 20 is mechanically or electrically connected to the driven wheels to apply a power to the driven wheels (for example, an optimum powering control described later), to execute an autonomous driving control (for example, an economy vehicle speed control or an economy inter-vehicle distance control described later) to autonomously drive the own vehicle 100 in a first drive mode in which control values of the own vehicle 100 (for example, an own vehicle speed V, the preceding vehicle distance DF, or a preceding vehicle arrival time TF described later) are increased or decreased within a set control range (for example, a set vehicle speed range R_V, a set preceding vehicle distance range R_DF, or a set preceding vehicle arrival time TF_S described later).

In this embodiment, mechanically connecting the power device 20 to the driven wheels to apply the power to the driven wheels means inputting the power output from the internal combustion engine 21 to the driven wheels of the own vehicle 100, and inputting the power to the driven wheels in this manner causes the own vehicle 100 to run. Also, in this embodiment, electrically connecting the power device 20 to input the power to the driven wheels means inputting the power output from the electric motor 22 to the driven wheels of the own vehicle 100, and inputting the power to the driven wheels in this manner causes the own vehicle 100 to run.

Furthermore, the vehicle driving assistance device 10 is configured to be able to execute the autonomous driving control (for example, a normal vehicle speed control or a normal inter-vehicle distance control described later) in a second motion mode which maintains the control values of the own vehicle 100 (for example, the own vehicle speed V, the preceding vehicle distance DF, or the preceding vehicle arrival time TF described later) at set control values (for example, a set vehicle speed V_S, a set preceding vehicle distance DF_S, or the set preceding vehicle arrival time TF_S described later).

Furthermore, the vehicle driving assistance device 10 is configured to be able to select, as a drive mode of the own vehicle 100, either the first drive mode (for example, a hybrid drive mode described later) in which the power other than the power generated by the electric power of the electric power storage device can be used as the power for driving the own vehicle 100, or a second drive mode (for example, a motor drive mode described later) in which only the power generated by the above-mentioned electric power is used, and selectively executing the autonomous driving control in the first drive mode and the autonomous driving control in the second drive mode.

In other words, the vehicle driving assistance device 10 is configured to selectively execute a vehicle speed increase/decrease control (for example, the economy vehicle speed control described later) which drives the own vehicle 100 autonomously while increasing or decreasing the vehicle speed of the own vehicle 100 within the set vehicle speed range, and an inter-vehicle distance increase/decrease control (for example, the economy inter-vehicle distance control described later) which drives the own vehicle 100 autonomously while increasing or decreasing the inter-vehicle distance between the own vehicle 100 and another vehicle (for example, the preceding vehicle 200) in the vicinity of the own vehicle 100 within a set inter-vehicle distance range, or while increasing or decreasing a period of time required for the own vehicle 100 to travel the inter-vehicle distance within a set time range.

Furthermore, the vehicle driving assistance device 10 is configured to selectively execute a vehicle speed maintenance control (for example, the normal vehicle speed control described later) which drives the own vehicle 100 autonomously while maintaining the vehicle speed of the own vehicle 100 at the set vehicle speed, and an inter-vehicle distance maintenance control (for example, the normal inter-vehicle distance control described later) which drives the own vehicle 100 autonomously while maintaining the inter-vehicle distance between the own vehicle 100 and another vehicle (for example, the preceding vehicle 200) in the vicinity of the own vehicle 100 at the set inter-vehicle distance, or while maintaining the period of time required for the own vehicle 100 to travel the above inter-vehicle distance at a set time.

Furthermore, the vehicle driving assistance device 10 is configured to be able to execute the vehicle speed increase/decrease control and the inter-vehicle distance increase/decrease control (for example, the economy vehicle speed control and the economy inter-vehicle distance control described later) in the first drive mode (for example, the hybrid drive mode described later) in which both the internal combustion engine 21 and the electric motor 22 or only the internal combustion engine 21 are operated to apply the power to the own vehicle 100 and drive the own vehicle 100, and in the second drive mode (for example, the motor drive mode described later) in which only the electric motor 22 is operated to apply the power to the own vehicle 100 and drive the own vehicle 100.

Furthermore, the vehicle driving assistance device 10 is configured to selectively execute the power control in the first state in which the power generation loss in the power device 20 of the own vehicle 100 or the power transmission loss from the power device 20 to the driven wheels of the own vehicle 100 is reduced (for example, the coasting control described later), and the power control in the second state in which the power device 20 is mechanically or electrically connected to the driven wheels to apply the power to the driven wheels (for example, the optimum powering control described later), to execute the vehicle speed increase/decrease control and the inter-vehicle distance increase/decrease control (for example, the economy vehicle speed control and the economy inter-vehicle distance control described later).

It should be noted that in this embodiment, the vehicle driving assistance device 10 can realize the first state in which the power generation loss in the power device 20 is reduced by reducing an amount (or an engine consumed energy amount) of energy consumed to generate the power in the internal combustion engine 21 by, for example, stopping the operation of the internal combustion engine 21, or by reducing an amount (or a motor consumed energy amount) of energy consumed to generate the power by the electric motor 22 by, for example, stopping a supply of the electric power from the electric power storage device 41 to the electric motor 22.

In this embodiment, the vehicle driving assistance device 10 can realize the first state in which the power transmission loss from the power device 20 to the driven wheels of the own vehicle 100 is reduced by, for example, putting a so-called clutch in a non-connected state, thereby cutting off a power transmission path from the power device 20 to the driven wheels of the own vehicle 100.

In addition, in this embodiment, the vehicle driving assistance device 10 establishes a transmission path from the power device 20 to the driven wheels of the own vehicle 100, and applies the power from the internal combustion engine 21 to the driven wheels of the own vehicle 100 via the transmission path, thereby realizing the second state in which the power device 20 is mechanically connected to the driven wheels of the own vehicle 100 to apply the power to the driven wheels. More specifically, the vehicle driving assistance device 10 executes the optimum powering control described later, thereby realizing the second state in which the power device 20 is mechanically connected to the driven wheels of the own vehicle 100 to apply the power to the driven wheels.

In addition, in this embodiment, the vehicle driving assistance device 10 establishes a transmission path from the power device 20 to the driven wheels of the own vehicle 100, and applies the power from the electric motor 22 to the driven wheels of the own vehicle 100 via the transmission path, thereby realizing the second state in which the power device 20 is electrically connected to the driven wheels to apply the power to the driven wheels.

Next, controls executed by the vehicle driving assistance device 10 will be described in more detail using as an example a case where the other vehicle around the own vehicle 100 is the preceding vehicle 200.

The vehicle driving assistance device 10 executes the autonomous driving control as an automatic driving control or an autonomous operation control. The autonomous driving control is a control for driving the own vehicle 100 by autonomously controlling the operation of the power device 20 and the braking device 30 to accelerate and decelerate the own vehicle 100, and in this embodiment includes an inter-vehicle distance control and a vehicle speed control.

As shown in FIG. 2A, the inter-vehicle distance control is a control which is executed when the preceding vehicle 200 is present in front of the own vehicle 100, and autonomously accelerates and decelerates the own vehicle 100 based on the set preceding vehicle distance DF_S. The set preceding vehicle distance DF_S is the preceding vehicle distance DF set by the driver as a control target for the inter-vehicle distance control.

Alternatively, the inter-vehicle distance control may be a control executed when the preceding vehicle 200 is present in front of the own vehicle 100, and autonomously accelerates and decelerates the own vehicle 100 based on the set preceding vehicle arrival time TF_S. The set preceding vehicle arrival time TF_S is the preceding vehicle arrival time TF set by the driver as the control target for the inter-vehicle distance control. The preceding vehicle arrival time TF is a value acquired by dividing the preceding vehicle distance DF by the own vehicle speed V (TF=DF/V). Therefore, the preceding vehicle arrival time TF is a period of time required for the own vehicle 100 to travel the preceding vehicle distance DF.

More specifically, the inter-vehicle distance control includes the normal inter-vehicle distance control and the economy inter-vehicle distance control.

The normal inter-vehicle distance control is one of normal autonomous driving controls, and is a control which drives the own vehicle 100 autonomously while maintaining the preceding vehicle distance DF at the set preceding vehicle distance DF_S. Alternatively, the normal inter-vehicle distance control may be a control which drives the own vehicle 100 autonomously while maintaining the preceding vehicle arrival time TF at the set preceding vehicle arrival time TF_S. Therefore, the normal inter-vehicle distance control is a so-called following driving control or adaptive cruise control.

It should be noted that the vehicle driving assistance device 10 may be configured to execute the normal vehicle speed control (or a constant speed control) described later when the own vehicle speed V increases and reaches the set vehicle speed V_S during the execution of the normal inter-vehicle distance control.

The economy inter-vehicle distance control is one of economy autonomous driving controls, and a control which starts the coasting control to cause the own vehicle 100 to coast when the preceding vehicle distance DF decreases and reaches a lower limit (or a lower limit preceding vehicle distance DF_L) of a predetermined range (or the set preceding vehicle distance range R_DF), and starts a powering control (or the optimum powering control) of powering the own vehicle 100 when the preceding vehicle distance DF increases and reaches an upper limit (or an upper limit preceding vehicle distance DF_U) of the set preceding vehicle distance range R_DF, thereby driving the own vehicle 100 autonomously while increasing or decreasing the preceding vehicle distance DF within the set preceding vehicle distance range R_DF. In other words, the economy inter-vehicle distance control is a control which alternates between powering and coasting the own vehicle 100 while allowing the preceding vehicle distance DF to vary within the predetermined range (or the set preceding vehicle distance range R_DF).

Alternatively, the economy inter-vehicle distance control is a control which drives the own vehicle 100 autonomously while increasing or decreasing the preceding vehicle arrival time TF within a set preceding vehicle time range R_TF by starting the coasting control to cause the own vehicle 100 to coast when the preceding vehicle arrival time TF decreases and reaches the lower limit (or a lower limit preceding vehicle time TF_L) of a predetermined range (or the set preceding vehicle time range R_TF), and starting the powering control (or the optimum powering control) of powering the own vehicle 100 when the preceding vehicle arrival time TF increases and reaches the upper limit (or an upper limit preceding vehicle time TF_U) of the set preceding vehicle time range R_TF. In other words, the economy inter-vehicle distance control is a control which alternates between powering and coasting the own vehicle 100 while allowing the preceding vehicle arrival time TF to vary within the predetermined range (or the set preceding vehicle time range R_TF).

It should be noted that in this embodiment, the set preceding vehicle distance range R_DF is set to a range which includes the set preceding vehicle distance DF_S. More specifically, the set preceding vehicle distance range R_DF is set by setting the upper limit preceding vehicle distance DF_U to the inter-vehicle distance which is a predetermined value (or a control inter-vehicle distance width dD) greater than the set preceding vehicle distance DF_S (DF_U=DF_S+dD), and setting the lower limit preceding vehicle distance DF_L to the inter-vehicle distance which is the predetermined value (or the control inter-vehicle distance width dD) smaller than the set preceding vehicle distance DF_S (DF_L=DF_S-dD).

Furthermore, in this embodiment, the set preceding vehicle time range R_TF is set to a range which includes the set preceding vehicle arrival time TF_S. More specifically, the set preceding vehicle time range R_TF is set by setting the upper limit preceding vehicle time TF_U to a time which is greater than the set preceding vehicle arrival time TF_S by a predetermined value (or a control preceding vehicle arrival time width dT) (TF_U=TF_S+dT), and setting the lower limit preceding vehicle time TF_L to a time which is less than the set preceding vehicle arrival time TF_S by the predetermined value (or the control preceding vehicle arrival time width dT) (TF_L=TF_S-dT).

The optimum powering control is a control which controls the operation of the power device 20 such that the power is output from the power device 20 with a maximum or near-maximum energy efficiency, and in particular, a control which operates the internal combustion engine 21 at an optimum operating point (or an operating point near the optimum operating point). The coasting control is a control which controls the operation of the power device 20 such that the own vehicle 100 coasts.

On the other hand, as shown in FIG. 2B, the vehicle speed control is a control which is executed when no preceding vehicle 200 is present in front of the own vehicle 100, and autonomously controls a travelling speed of the own vehicle 100 (or the own vehicle speed V) based on the set vehicle speed V_S. The set vehicle speed V_S is the travelling speed of the own vehicle 100 (or the own vehicle speed V) set by the driver as the control target for the vehicle speed control.

As shown in FIG. 1, the own vehicle 100 is equipped with a vehicle speed detection device 61 such as wheel speed sensors. The vehicle speed detection device 61 is electrically connected to the ECU 90. The vehicle driving assistance device 10 acquires the own vehicle speed V by the vehicle speed detection device 61.

More specifically, the vehicle speed control includes the normal vehicle speed control and the economy vehicle speed control.

The normal vehicle speed control is one of the normal autonomous driving controls, and is a control which drives the own vehicle 100 autonomously while maintaining the own vehicle speed V at the set vehicle speed V_S. Therefore, the normal vehicle speed control is a so-called constant speed control or cruise control.

The economy vehicle speed control is a control which drives the own vehicle 100 autonomously while increasing or decreasing the own vehicle speed V within the set vehicle speed range R_V by starting the coasting control when the own vehicle speed V increases and reaches an upper limit (or an upper limit vehicle speed V_U) of a predetermined range (or the set vehicle speed range R_V), and starting the optimum powering control when the own vehicle speed V decreases and reaches a lower limit (or a lower limit vehicle speed V_L) of the set vehicle speed range R_V. In other words, the economy vehicle speed control is a control which alternates between powering and coasting the own vehicle 100 while allowing the own vehicle speed V to vary within the predetermined range (or the set vehicle speed range R_V).

It should be noted that in this embodiment, the set vehicle speed range R_V is set to a range including the set vehicle speed V_S. More specifically, the set vehicle speed range R_V is set by setting the upper limit vehicle speed V_U to the vehicle speed which is greater than the set vehicle speed V_S by a predetermined value (or a control vehicle speed width dV) (V_U=V_S+dV), and setting the lower limit vehicle speed V_L to the vehicle speed which is lower than the set vehicle speed V_S by a predetermined value (or the control vehicle speed width dV) (V_L=V_S−dV).

### <Specific Operation of Vehicle Driving Assistance Device>

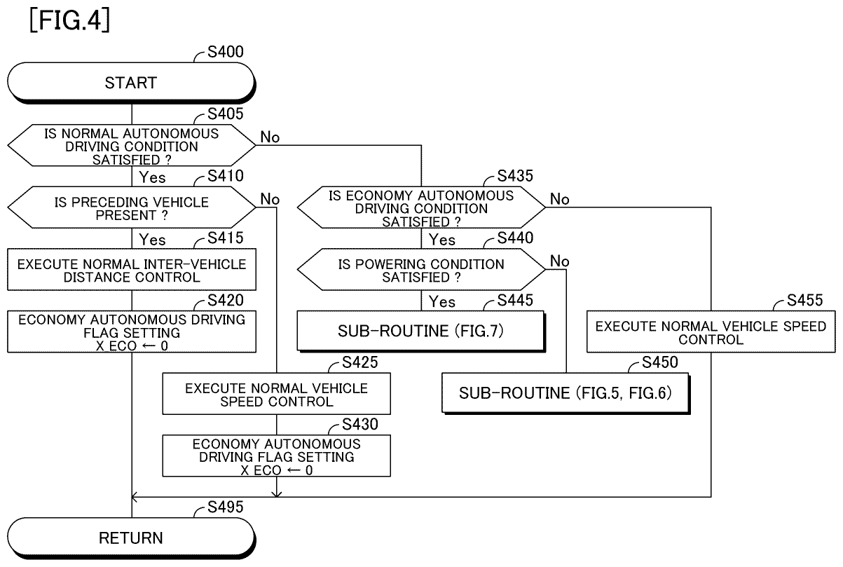

Next, a specific operation of the vehicle driving assistance device 10 will be described. The vehicle driving assistance device 10 executes a routine shown in FIG. 4 at a predetermined calculation cycle to execute the autonomous driving control.

When a predetermined timing arrives, the vehicle driving assistance device 10 starts a process from a step S400 of the routine shown in FIG. 4, and proceeds with the process to a step S405 to determine whether or not a normal autonomous driving condition C1 is satisfied.

The normal autonomous driving condition C1 is a condition that an autonomous driving executable condition C2 is satisfied, the execution of the autonomous driving control is requested, and the execution of the economy autonomous driving control (or an economy driving control) is not requested. It should be noted that the economy autonomous driving control includes the economy vehicle speed control and the economy inter-vehicle distance control. Also, the economy autonomous driving control is a control which drives the own vehicle 100 in a pulse-and-glide manner.

The autonomous driving executable condition C2 is a condition that, for example, systems such as the surrounding information detection device 50 necessary for the execution of the autonomous driving control are functioning normally, or a condition that a gradient of a road on which the own vehicle 100 travels is not relatively large, and the situation is not such that it is determined that the execution of the economy autonomous driving control is undesirable. It should be noted that the normal autonomous driving condition C1 does not have to include the condition that the autonomous driving executable condition C2 is satisfied.

As shown in FIG. 1, the own vehicle 100 is equipped with an autonomous driving request operator 71 such as a driving assistance button and an economy autonomous driving request operator 72 such as an economy driving button. The autonomous driving request operator 71 and the economy autonomous driving request operator 72 are electrically connected to the ECU 90. The driver can request the vehicle driving assistance device 10 to execute the autonomous driving control by operating the autonomous driving request operator 71. The driver can also request the vehicle driving assistance device 10 to execute the economy autonomous driving control by operating the economy autonomous driving request operator 72.

When the vehicle driving assistance device 10 determines “Yes” at the step S405, the vehicle driving assistance device 10 proceeds with the process to a step S410 to determine whether or not the preceding vehicle 200 is present.

When the vehicle driving assistance device 10 determines “Yes” at the step S410, the vehicle driving assistance device 10 proceeds with the process to a step S415 to execute the normal inter-vehicle distance control as the autonomous driving control. Next, the vehicle driving assistance device 10 proceeds with the process to a step S420 to set a value of an economy autonomous driving flag X_ECO to “0”, and then the vehicle driving assistance device 10 proceeds with the process to a step S495 to terminate the process of this routine once.

On the other hand, when the vehicle driving assistance device 10 determines “No” at the step S410, the vehicle driving assistance device 10 proceeds with the process to a step S425 to execute the normal vehicle speed control as the autonomous driving control. Next, the vehicle driving assistance device 10 proceeds with the process to a step S430 to set the value of the economy autonomous driving flag X_ECO to “0”, and then the vehicle driving assistance device 10 proceeds with the process to the step S495 to terminate the process of this routine once.

When the vehicle driving assistance device 10 determines “No” at the step S405, the vehicle driving assistance device 10 proceeds with the process to a step S435 to determine whether or not an economy autonomous driving condition C3 is satisfied.

The economy autonomous driving condition C3 is a condition that the autonomous driving executable condition C2 is satisfied, the execution of the autonomous driving control is requested, and the execution of the economy autonomous driving control is requested. It should be noted that the economy autonomous driving condition C3 does not have to include the condition that the autonomous driving executable condition C2 is satisfied.

When the vehicle driving assistance device 10 determines “Yes” at the step S435, the vehicle driving assistance device 10 proceeds with the process to a step S440 to determine whether or not a powering condition C4 described later, is satisfied.

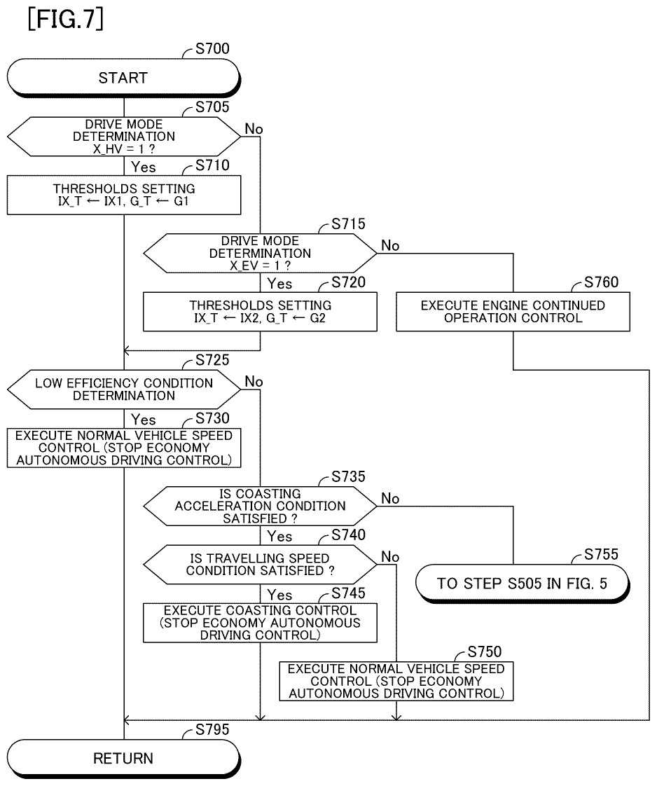

When the vehicle driving assistance device 10 determines “Yes” at the step S440, the vehicle driving assistance device 10 proceeds with the process to a step S445 to execute a routine shown in FIG. 7. This routine will be described later.

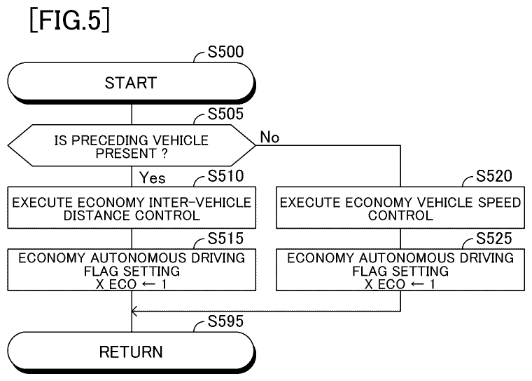

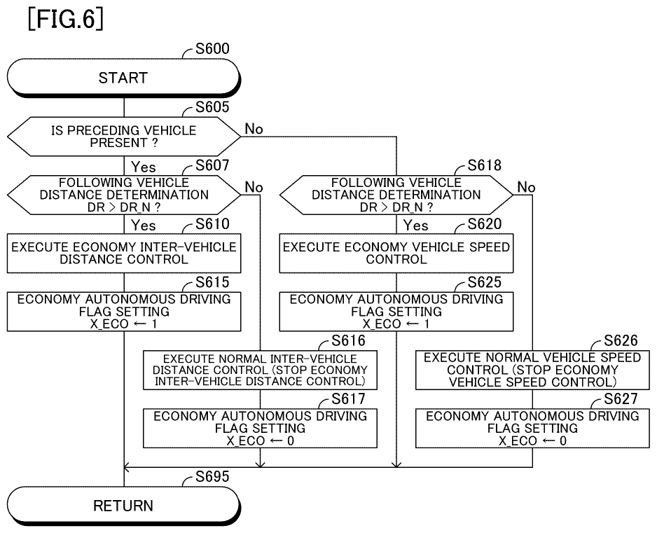

On the other hand, when the vehicle driving assistance device 10 determines “No” at the step S440, the vehicle driving assistance device 10 proceeds with the process to a step S450 to executed a routine shown in FIG. 5 or FIG. 6.

Therefore, in the case where the vehicle driving assistance device 10 is configured to execute the routine shown in FIG. 5 when the vehicle driving assistance device 10 proceeds with the process to the step S450, the vehicle driving assistance device 10 starts a process from a step S500 of the routine shown in FIG. 5, and proceeds with the process to a step S505 to determine whether or not the preceding vehicle 200 is present.

When the vehicle driving assistance device 10 determines “Yes” at the step S505, the vehicle driving assistance device 10 proceeds with the process to a step S510 to execute the economy inter-vehicle distance control as the autonomous driving control. Next, the vehicle driving assistance device 10 proceeds with the process to a step S515 to set the value of the economy autonomous driving flag X_ECO to “1”, and then the vehicle driving assistance device 10 proceeds with the process to a step S595 to terminate the process of this routine once.

On the other hand, when the vehicle driving assistance device 10 determines “No” at the step S505, the vehicle driving assistance device 10 proceeds with the process to a step S520 to execute the economy vehicle speed control as the autonomous driving control. Next, the vehicle driving assistance device 10 proceeds with the process to a step S525 to set the value of the economy autonomous driving flag X_ECO to “1”, and then proceeds with the process to the step S595 to terminate the process of this routine once.

Alternatively, in the case where the vehicle driving assistance device 10 is configured to execute the routine shown in FIG. 6 when the vehicle driving assistance device 10 proceeds with the process to the step S450, the vehicle driving assistance device 10 starts a process from a step S600 of the routine shown in FIG. 6, and proceeds with the process to a step S605 to determine whether or not the preceding vehicle 200 is present.

When the vehicle driving assistance device 10 determines “Yes” at the step S605, the vehicle driving assistance device 10 proceeds with the process to a step S607 to determine whether or not the following vehicle distance DR is greater than a predetermined distance (or a proximity determination distance DR_N).

It should be noted that the vehicle driving assistance device 10 may be configured to determine whether or not a following vehicle arrival time TR is longer than a predetermined time (or a proximity determination time TR_N) at the step S607. The following vehicle arrival time TR is a value acquired by dividing the following vehicle distance DR by the vehicle speed of the following vehicle 300 (or a following vehicle speed VR) (TR=DR/VR). Therefore, the following vehicle arrival time TR is a period of time required for the following vehicle 300 to travel the following vehicle distance DR.

When the vehicle driving assistance device 10 determines “Yes” at the step S607, the vehicle driving assistance device 10 proceeds with the process to a step S610 to execute the economy inter-vehicle distance control as the autonomous driving control. Next, the vehicle driving assistance device 10 proceeds with the process to a step S615 to set the value of the economy autonomous driving flag X_ECO to “1”, and then proceeds with the process to a step S695 to terminate the process of this routine once.

On the other hand, when the vehicle driving assistance device 10 determines “No” at the step S607, the vehicle driving assistance device 10 proceeds with the process to a step S616 to suspend the economy inter-vehicle distance control and execute the normal inter-vehicle distance control. Next, the vehicle driving assistance device 10 proceeds with the process to a step S617 to set the value of the economy autonomous driving flag X_ECO to “0”, and then proceeds with the process to the step S695 to terminate the process of this routine once.

In this way, the vehicle driving assistance device 10 is configured to be able to execute the normal inter-vehicle distance control of maintaining the preceding vehicle distance DF at the set preceding vehicle distance DF_S (or the autonomous driving control in the second motion mode in which the control value is maintained at the set control value), and switch the control of autonomously driving the own vehicle 100 (or a mode of autonomously driving the own vehicle 100) from the economy inter-vehicle distance control to the normal inter-vehicle distance control (or from a first motion mode to the second motion mode) when a condition that the following vehicle distance DR is equal to or less than the proximity determination distance DR_N or the following vehicle arrival time TR is equal to or less than the proximity determination time TR_N (or a motion mode switching condition that the following vehicle detection device which detects the following vehicle 300 is normal, the following vehicle 300 is detected, and the distance between the following vehicle 300 and the own vehicle 100 is equal to or less than a predetermined distance, or a period of time required for the own vehicle 100 to travel the distance between the following vehicle 300 and the own vehicle 100 is equal to or less than a predetermined period of time), is satisfied during the execution of the economy inter-vehicle distance control (or the autonomous driving control in the first motion mode).

In the case where the own vehicle 100 is driven autonomously by the economy inter-vehicle distance control, while the following vehicle 300 is present, if the preceding vehicle distance DF increases or decreases excessively, the following vehicle 300 increases or decreases its vehicle speed significantly, which may hinder smooth traffic of surrounding vehicles including the following vehicle 300.

According to the vehicle driving assistance device 10, when the following vehicle 300 is relatively close to the own vehicle 100, the control of autonomously driving the own vehicle 100 is switched from the economy inter-vehicle distance control to the normal inter-vehicle distance control. This maintains the preceding vehicle distance DF constant. Therefore, even when the following vehicle 300 is relatively close to the own vehicle 100, the own vehicle 100 can be driven autonomously such that the smooth traffic of the surrounding vehicles is maintained.

Furthermore, the vehicle driving assistance device 10 is configured to be able to execute the normal inter-vehicle distance control (or the inter-vehicle distance maintenance control) of autonomously driving the own vehicle 100 while maintaining the preceding vehicle distance DF (or the inter-vehicle distance) at the set preceding vehicle distance DF_S (or the set inter-vehicle distance) or while maintaining the preceding vehicle arrival time TF (or a period of time required for the own vehicle 100 to travel the inter-vehicle distance between the own vehicle 100 and the surrounding vehicle) at the set preceding vehicle arrival time TF_S (or the set time). In addition, the vehicle driving assistance device 10 is configured to suspend the economy inter-vehicle distance control (or the inter-vehicle distance increase/decrease control) and execute the normal inter-vehicle distance control (or the inter-vehicle distance maintenance control) when a condition that the following vehicle distance DR is equal to or less than the proximity determination distance DR_N or the following vehicle arrival time TR is equal to or less than the proximity determination time TR_N (or the motion mode switching condition that the following vehicle detection device which detects the following vehicle 300 is normal, the following vehicle 300 is detected, and the distance between the following vehicle 300 and the own vehicle 100 is equal to or less than a predetermined distance, or the period of time required for the own vehicle 100 to travel the distance between the following vehicle 300 and the own vehicle 100 is equal to or less than a predetermined period of time), is satisfied during the execution of the economy inter-vehicle distance control (or the inter-vehicle distance increase/decrease control).

In the case where the own vehicle 100 is driven autonomously by the economy inter-vehicle distance control, while the following vehicle 300 is present, if the preceding vehicle distance DF increases or decreases excessively, the following vehicle 300 increases or decreases its vehicle speed significantly, which may hinder the smooth traffic of the surrounding vehicles including the following vehicle 300.

According to the vehicle driving assistance device 10, when the following vehicle 300 is relatively close to the own vehicle 100, the economy inter-vehicle distance control is suspended and the normal inter-vehicle distance control is executed. This maintains the preceding vehicle distance DF constant. Therefore, even when the following vehicle 300 is relatively close to the own vehicle 100, the own vehicle 100 can be driven autonomously such that the smooth traffic of the surrounding vehicles is maintained.

On the other hand, when the vehicle driving assistance device 10 determines “No” at the step S605, the vehicle driving assistance device 10 proceeds with the process to a step S618 to determine whether or not the following vehicle distance DR is greater than the proximity determination distance DR_N.

It should be noted that the vehicle driving assistance device 10 may be configured to determine whether or not the following vehicle arrival time TR is longer than the proximity determination time TR_N at the step S618.

When the vehicle driving assistance device 10 determines “Yes” at the step S618, the vehicle driving assistance device 10 proceeds with the process to a step S620 to execute the economy vehicle speed control as the autonomous driving control. Next, the vehicle driving assistance device 10 proceeds with the process to a step S625 to set the value of the economy autonomous driving flag X_ECO to “1”, and then proceeds with the process to the step S695 to terminate the process of this routine once.

On the other hand, when the vehicle driving assistance device 10 determines “No” at the step S618, the vehicle driving assistance device 10 proceeds with the process to a step S626 to suspend the economy vehicle speed control and execute the normal vehicle speed control. Next, the vehicle driving assistance device 10 proceeds with the process to a step S627 to set the value of the economy autonomous driving flag X_ECO to “0”, and then the vehicle driving assistance device 10 proceeds with the process to the step S695 to terminate the process of this routine once.

In this way, the vehicle driving assistance device 10 is configured to be able to execute the normal vehicle speed control of maintaining the own vehicle speed V at the set vehicle speed V_S (or the autonomous driving control of autonomously driving the own vehicle 100 in the second motion mode in which the control value is maintained at the set control value), and switch the control of autonomously driving the own vehicle 100 (or the mode of autonomously driving the own vehicle 100) from the economy vehicle speed control to the normal vehicle speed control (or from the first motion mode to the second motion mode) when the condition that the following vehicle distance DR is equal to or less than the proximity determination distance DR_N or the following vehicle arrival time TR is equal to or less than the proximity determination time TR_N (or the motion mode switching condition that the following vehicle detection device which detects the following vehicle 300 is normal, the following vehicle 300 is detected, and the distance between the following vehicle 300 and the own vehicle 100 is equal to or less than a predetermined distance, or the period of time required for the own vehicle 100 to travel the distance between the following vehicle 300 and the own vehicle 100 is equal to or less than a predetermined period of time), is satisfied during the execution of the economy vehicle speed control (or the autonomous driving control in the first motion mode).

In the case where the own vehicle 100 is driven autonomously by the economy vehicle speed control, while the following vehicle 300 is present, if the own vehicle speed V increases or decreases excessively, the following vehicle 300 increases or decreases its vehicle speed significantly, which may hinder the smooth traffic of the surrounding vehicles including the following vehicle 300.

According to the vehicle driving assistance device 10, when the following vehicle 300 is relatively close to the own vehicle 100, the control of autonomously driving the own vehicle 100 is switched from the economy vehicle speed control to the normal vehicle speed control. This maintains the own vehicle speed V constant. Therefore, even when the following vehicle 300 is relatively close to the own vehicle 100, the own vehicle 100 can be autonomously driven such that the smooth traffic of surrounding vehicles is maintained.

The vehicle driving assistance device 10 is also configured to be able to execute the normal vehicle speed control (or the vehicle speed maintenance control) which drives the own vehicle 100 autonomously while maintaining the own vehicle speed V at the set vehicle speed V_S. In addition, the vehicle driving assistance device 10 is configured to suspend the economy vehicle speed control (or the vehicle speed increase/decrease control) and execute the normal vehicle speed control (or the vehicle speed maintenance control) when the condition that the following vehicle distance DR is equal to or less than the proximity determination distance DR_N or the following vehicle arrival time TR is equal to or less than the proximity determination time TR_N (or the motion mode switching condition that the following vehicle detection device which detects the following vehicle 300 is normal, the following vehicle 300 is detected, and the distance between the following vehicle 300 and the own vehicle 100 is equal to or less than a predetermined distance, or the period of time required for the own vehicle 100 to travel the distance between the following vehicle 300 and the own vehicle 100 is equal to or less than a predetermined period of time), is satisfied during the execution of the economy vehicle speed control (or the vehicle speed increase/decrease control).

In the case where the own vehicle 100 is driven autonomously by the economy vehicle speed control, while the following vehicle 300 is present, if the own vehicle speed V increases or decreases excessively, the following vehicle 300 increases or decreases its vehicle speed significantly, which may hinder the smooth traffic of the surrounding vehicles including the following vehicle 300.

According to the vehicle driving assistance device 10, when the following vehicle 300 is relatively close to the own vehicle 100, the economy vehicle speed control is suspended and the normal vehicle speed control is executed. This maintains the own vehicle speed V constant. Therefore, even when the following vehicle 300 is relatively close to the own vehicle 100, the own vehicle 100 can be driven autonomously such that the smooth traffic of the surrounding vehicles is maintained.

When the vehicle driving assistance device 10 determines “No” at the step S435 of the routine shown in FIG. 4, the vehicle driving assistance device 10 proceeds with the process to a step S455, the vehicle driving assistance device 10 executes the normal vehicle speed control, and then the vehicle driving assistance device 10 proceeds with the process to the step S495 to terminate the process of this routine once.

Next, the routine shown in FIG. 7 will be described.

The powering condition C4 determined at the step S440 of the routine shown in FIG. 4 is a condition that the value of the economy autonomous driving flag X_ECO is “1” and the optimum powering control is executed. That is, the powering condition C4 is a condition that a deceleration of the own vehicle 100 is not required during the execution of the economy autonomous driving control.

When the vehicle driving assistance device 10 determines “Yes” at the step S440 of the routine shown in FIG. 4 and proceeds with the process to the step S445, the vehicle driving assistance device 10 starts a process from a step S700 of the routine shown in FIG. 7, and proceeds with the process to a step S705 to determine whether or not a value of a hybrid drive mode flag X_HV is “1”.

The value of the hybrid drive mode flag X_HV is set to “1” while the own vehicle 100 is currently driven in the hybrid drive mode, and is set to “0” while the own vehicle 100 is not currently driven in the hybrid drive mode. The hybrid drive mode is a mode in which the own vehicle 100 is driven by operating both the internal combustion engine 21 and the electric motor 22 or only the internal combustion engine 21 depending on a required power P_REQ. It should be noted that the required power P_REQ is the power required as the power output from the power device 20.

When the vehicle driving assistance device 10 determines “Yes” at the step S705, the vehicle driving assistance device 10 proceeds with the process to a step S710 to set a low efficiency index threshold IX_T to a first low efficiency index threshold IX1 and set a coasting acceleration rate threshold G_T to a first coasting acceleration rate threshold G1, and the vehicle driving assistance device 10 proceeds with the process to a step S725. The low efficiency index threshold IX_T is a threshold used in a determination at a step S725, and the coasting acceleration rate threshold G_T is a threshold used in a determination at a step S735 described later.

On the other hand, when the vehicle driving assistance device 10 determines “No” at the step S705, the vehicle driving assistance device 10 proceeds with the process to a step S715 to determine whether or not a value of a motor drive mode flag X_EV is “1”.

The value of the motor drive mode flag X_EV is set to “1” while the own vehicle 100 is currently driven in the motor drive mode, and is set to “0” while the own vehicle 100 is not currently driven in the motor drive mode. The motor drive mode is a mode in which the own vehicle 100 is driven by operating only the electric motor 22.

When the vehicle driving assistance device 10 determines “Yes” at the step S715, the vehicle driving assistance device 10 proceeds with the process to a step S720 to set the low efficiency index threshold IX_T to a second low efficiency index threshold IX2 and set the coasting acceleration rate threshold G_T to a second coasting acceleration rate threshold G2, and the vehicle driving assistance device 10 proceeds with the process to the step S725. It should be noted that the second low efficiency index threshold IX2 is set to a value greater than the first low efficiency index threshold IX1, and the second coasting acceleration rate threshold G2 is set to a value greater than the first coasting acceleration rate threshold G1.

When the vehicle driving assistance device 10 proceeds with the process to the step S725, the vehicle driving assistance device 10 determines whether or not a low efficiency condition C5 is satisfied.

The low efficiency condition C5 is a condition that a driving energy efficiency (or an energy efficiency in the power device 20 related to the driving of the own vehicle 100) is lower than the driving energy efficiency when the own vehicle 100 is driven by the normal vehicle speed control, taking into account the gradient (or a road gradient θ) of a road on which the own vehicle 100 travels in the case where the economy autonomous driving control (or the economy inter-vehicle distance control or the economy vehicle speed control) is executed to drive the own vehicle 100 while switching the control (or a vehicle driving control) for controlling the driving of the own vehicle 100 between the coasting control and the optimum powering control.

In this embodiment, the low efficiency condition C5 is a condition that a low efficiency index IX is greater than the low efficiency index threshold IX_T, as shown in the following expression 1.

$$IX > IXth \qquad ( 1 )$$

The low efficiency index IX is an index which indicates a degree to which the driving energy efficiency (or the driving energy efficiency) related to the driving of the own vehicle 100 decreases when the economy autonomous driving control is executed, compared to the energy efficiency when the normal vehicle speed control is executed.

In this embodiment, the low efficiency index IX is acquired by calculation according to the following expression 2.

$$IX = \vert Gd \vert - k \cdot \vert Ga \vert \qquad ( 2 )$$

$$Gd = - F / M + g \cdot sin θ \qquad ( 3 )$$

$$Ga = ( P\_OPT - F ) / M + g \cdot sin θ \qquad ( 4 )$$

In the expression 2, “Gd” is an acceleration rate (or a coasting acceleration rate) of the own vehicle 100 which is realized when the coasting control is executed, and is acquired by calculation according to the expression 3 above. The coasting acceleration rate Gd is acquired as a negative value when the own vehicle speed V is decreasing, and as a positive value when the own vehicle speed V is increasing.

In addition, in the expression 2, “Ga” is the acceleration rate (or an optimum powering acceleration rate) of the own vehicle 100 which is realized when the optimum powering control is executed, and is acquired by calculation according to the expression 4 above. The optimum powering acceleration rate Ga is also acquired as a negative value when the own vehicle speed V is decreasing, and is acquired as a positive value when the own vehicle speed V is increasing.

In addition, in the expressions 3 and 4, “F” is a travelling resistance of the own vehicle 100, and is acquired, for example, by calculation according to an expression 5 below. Furthermore, “M” is a weight of the own vehicle 100, “g” is a gravitational acceleration rate, and “0” is a road surface gradient. Furthermore, “P_OPT” is the power (or an optimum powering force) applied to the own vehicle 100 from the power device 20 when the optimum powering control is executed.

$$F = a \cdot V 2 + b \cdot V + c \qquad ( 5 )$$

In the expression 5, “V” is the travelling speed of the own vehicle 100 (or the own vehicle speed), and “a”, “b”, and “c” are coefficients determined such that the travelling resistance of the own vehicle 100 can be acquired with high accuracy based on the own vehicle speed V.

Furthermore, the low efficiency index threshold IX_T (or the first low efficiency index threshold IX1 and the second low efficiency index threshold IX2) is a predetermined value, and in the expression 1, “k” is a coefficient which is set to a predetermined value. The low efficiency index threshold IX_T and the coefficient k are set as follows.

That is, in the case where the own vehicle 100 travels on a flat road, when the own vehicle 100 is driven by the economy autonomous driving control (or the economy inter-vehicle distance control or the economy vehicle speed control) which controls the driving of the own vehicle 100 while switching between the coasting control and the optimum powering control, the coasting control is executed in response to the own vehicle 100 being requested to decelerate, so the driving energy efficiency is higher than when the own vehicle 100 is driven by the normal vehicle speed control.

However, in the case where the own vehicle 100 travels on an uphill road, when the own vehicle 100 is driven by the economy autonomous driving control, switching between the coasting control and the optimum powering control is frequently performed within a certain period of time, so there is a possibility that the driving energy efficiency is lower than when the own vehicle 100 is driven by the normal vehicle speed control. In particular, when the own vehicle 100 is driven autonomously in the hybrid drive mode, the internal combustion engine 21 is started and stopped frequently, so there is a high possibility that the driving energy efficiency decreases.

Therefore, in this embodiment, when the low efficiency index IX is acquired by calculation according to the expressions 2 to 4, a combination of the low efficiency index threshold value IX_T and the coefficient k at which the driving energy efficiency when the own vehicle 100 is driven by the economy autonomous driving control is equal to the driving energy efficiency when the own vehicle 100 is driven by the normal vehicle speed control, is acquired in advance by experiment or the like, in relation to the road gradient θ, the coasting acceleration rate Gd, and the optimum powering acceleration rate Ga, and the low efficiency index threshold value IX_T and the coefficient k are used in the expressions 1 and 2, respectively. It should be noted that in this embodiment, the coefficient k is set to a value greater than “0” and less than or equal to “1.”

Therefore, when the low efficiency index IX is greater than the low efficiency index threshold value IX_T, driving the own vehicle 100 by the normal vehicle speed control results in higher driving energy efficiency than driving the own vehicle 100 by the economy autonomous driving control.

From the above, it can be said that the vehicle driving assistance device 10 determines at the step S725 whether or not the driving energy efficiency is higher by continuing the economy autonomous driving control, or by terminating the economy autonomous driving control and executing the normal vehicle speed control.

It should be noted that the low efficiency condition C5 can also be said to be an uphill gradient condition that the road gradient θ is an uphill gradient greater than a predetermined uphill gradient threshold θup during the execution of the economy autonomous driving control. In this case, it can be said that the predetermined uphill gradient threshold θup is set to a gradient at which an absolute value of a deceleration rate of the own vehicle 100 when the own vehicle 100 is driven by the coasting control in the case where the road gradient θ is an uphill gradient, is equal to or greater than a predetermined value (or a predetermined deceleration rate threshold). Alternatively, it can be said that the predetermined uphill gradient threshold θup is set to a gradient at which the acceleration/deceleration rate of the own vehicle 100 when the own vehicle 100 is driven by the optimum powering control in the case where the road gradient θ is an uphill gradient, is equal to or less than a predetermined value (a predetermined acceleration rate threshold). Alternatively, it can be said that the predetermined uphill gradient threshold θup is set to a gradient when a ratio of an absolute value of the coasting acceleration rate Gd to the optimum powering acceleration rate Ga in the case where the road gradient θ is an uphill gradient, is greater than a predetermined ratio.

Furthermore, in order to prevent the vehicle driving control from frequently switching between the economy autonomous driving control and the normal vehicle speed control, a hysteresis may be provided to the low efficiency index threshold IX_T.

Furthermore, after the low efficiency condition C5 is satisfied and the vehicle driving control is switched from the economy autonomous driving control to the normal vehicle speed control, when it is determined that the preceding vehicle 200 is present during the execution of the normal vehicle speed control, the vehicle driving control is switched from the normal vehicle speed control to the normal inter-vehicle distance control.

Furthermore, after the low efficiency condition C5 is satisfied and the vehicle driving control is switched from the economy autonomous driving control to the normal vehicle speed control, the vehicle driving control is switched from the normal vehicle speed control to the economy autonomous driving control when the low efficiency condition C5 is no longer satisfied. That is, in this embodiment, when the low efficiency condition C5 is satisfied, the economy autonomous driving control is suspended, and then when the low efficiency condition C5 is no longer satisfied, the economy autonomous driving control is resumed. However, the economy autonomous driving control may be terminated when the low efficiency condition C5 is satisfied, and the economy autonomous driving control may not be resumed even when the low efficiency condition C5 is no longer satisfied.

Further, as shown in FIG. 1, the own vehicle 100 is equipped with a road gradient acquisition device 62. The road gradient acquisition device 62 is a device which acquires the gradient of the road on which the own vehicle 100 travels, and is, for example, a gyro sensor. The road gradient acquisition device 62 is electrically connected to the ECU 90. The vehicle driving assistance device 10 acquires the gradient of the road on which the own vehicle 100 travels as the road gradient θ by the road gradient acquisition device 62.

When the vehicle driving assistance device 10 determines “Yes” at the step S725, the vehicle driving assistance device 10 proceeds with the process to a step S730 to execute the normal vehicle speed control, and then the vehicle driving assistance device 10 proceeds with the process to a step S795 to terminate the process of this routine once.

In this way, the vehicle driving assistance device 10 is configured to be able to execute the normal vehicle speed control of maintaining the own vehicle speed V at the set vehicle speed V_S (or the autonomous driving control in a constant speed mode). In addition, the vehicle driving assistance device 10 is configured to suspend the economy autonomous driving control (or the autonomous driving control in first motion mode) and execute the normal vehicle speed control (or the autonomous driving control in the constant speed mode) when the low efficiency condition C5 (or a second condition) is satisfied. In addition, the low efficiency condition C5 (or the second condition) is a condition which is likely to be satisfied while the own vehicle 100 travels on the uphill road or while the own vehicle 100 travels at a relatively high speed (or while the own vehicle 100 travels at the vehicle speed equal to or higher than a predetermined vehicle speed). In addition, the low efficiency index threshold IX_T is set to the first low efficiency index threshold IX1 when the own vehicle 100 is driven in the hybrid drive mode (or the first drive mode), and is set to the second low efficiency index threshold IX2 when the own vehicle 100 is driven in the motor drive mode (or the second drive mode), and the first low efficiency index threshold IX1 is a value smaller than the second low efficiency index threshold IX2. Therefore, when the own vehicle 100 is driven autonomously by the economy autonomous driving control in the hybrid drive mode (or the first drive mode), the low efficiency condition C5 (or the second condition) is set to a condition which is more likely to be satisfied than when the own vehicle 100 is driven autonomously by the economy autonomous driving control in the motor drive mode (or the second drive mode).

While the own vehicle 100 travels on the uphill road or the own vehicle 100 travels at high speed, when the own vehicle 100 is driven autonomously by the coasting control, the own vehicle speed V may decrease significantly, and in addition the own vehicle speed V may not be increased appropriately even by driving the own vehicle 100 autonomously by the optimum powering control. Therefore, while the own vehicle 100 travels on the uphill road or the own vehicle 100 travels at high speed, if the own vehicle 100 is driven autonomously by the economy autonomous driving control, the effect of reducing the consumed energy amount is reduced.

Furthermore, when the own vehicle 100 is driven autonomously by the economy autonomous driving control in the hybrid drive mode, the set vehicle speed range R_V or the set preceding vehicle distance range R_DF is set to a wider range than when the own vehicle 100 is driven autonomously by the economy autonomous driving control in the motor drive mode, so if the own vehicle 100 is driven autonomously by the economy autonomous driving control in the hybrid drive mode in the case where the own vehicle 100 travels on the uphill road or the own vehicle travels at high speed, the effect of reducing the consumed energy amount decreases.

According to the vehicle driving assistance device 10, the low efficiency condition C5 is set to a condition which is likely to be satisfied while the own vehicle 100 travels on the uphill road or the own vehicle 100 travels at high speed, and is more likely to be satisfied when the own vehicle 100 is driven autonomously by the economy autonomous driving control in the hybrid drive mode than when the own vehicle 100 is driven autonomously by the economy autonomous driving control in the motor drive mode. In addition, when the low efficiency condition C5 is satisfied, the economy autonomous driving control is suspended and the normal vehicle speed control is executed. That is, while the own vehicle 100 travels on the uphill road or the own vehicle 100 travels at high speed, when the own vehicle 100 is driven autonomously by the economy autonomous driving control in the hybrid drive mode, the economy autonomous driving control is likely to be suspended and the normal vehicle speed control is likely to be executed. Therefore, a certain effect of reducing the consumed energy amount can be secured.

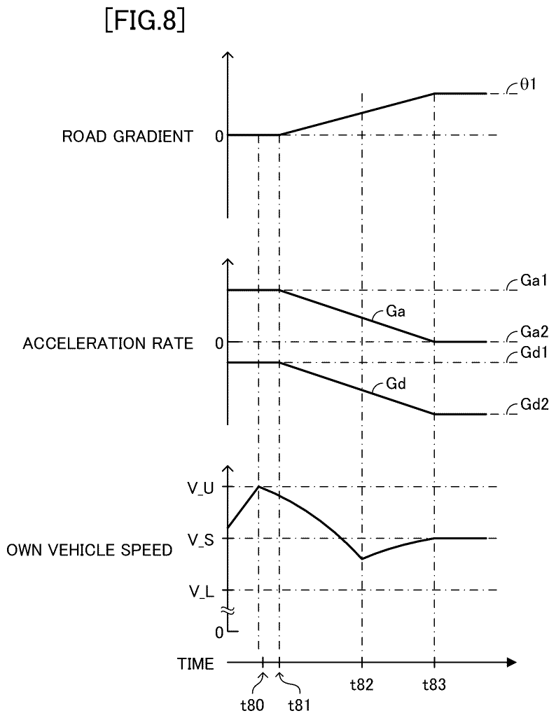

Furthermore, according to the vehicle driving assistance device 10, the own vehicle speed V is controlled as shown in FIG. 8. In the example shown in FIG. 8, the own vehicle 100 travels on a road with the road gradient θ of zero, i.e., a flat road, and the optimum powering control is executed until a time t50. Therefore, the own vehicle speed V gradually increases until the time t50. It should be noted that the optimum powering acceleration rate Ga and the coasting acceleration rate Gd at this time are a first optimum powering acceleration rate Ga1 and a first coasting acceleration rate Gd1, respectively. Moreover, the first optimum powering acceleration rate Ga1 is a positive value, and the first coasting acceleration rate Gd1 is a negative value.

Then, when the own vehicle speed V reaches the upper limit vehicle speed V_U at the time t50, the coasting control is started, and at this time, the own vehicle 100 travels on a road with the road gradient θ of zero, and therefore a flat road. Therefore, the own vehicle speed V starts to decrease. It should be noted that the optimum powering acceleration rate Ga and the coasting acceleration rate Gd at this time are also the first optimum powering acceleration rate Ga1 and the first coasting acceleration rate Gd1, respectively.

Then, at a time t51, the own vehicle 100 starts to travel on the uphill road. In the example shown in FIG. 8, the road gradient θ continues to increase from the time t51 to a time t53, and becomes a constant value θ1 after the time t53. Therefore, between the time t51 and the time t53, the optimum powering acceleration rate Ga and the coasting acceleration rate Gd gradually decrease. In other words, an absolute value of the optimum powering acceleration rate Ga gradually decreases, and the absolute value of the coasting acceleration rate Gd gradually increases. Then, after the time t53, the optimum powering acceleration rate Ga and the coasting acceleration rate Gd become constant at a second optimum powering acceleration rate Ga2 and a second coasting acceleration rate Gd2, respectively.

After the time t51, the own vehicle speed V continues to decrease, and in the example shown in FIG. 8, at a time t52, the low efficiency condition C5 is satisfied, the economy autonomous driving control is terminated, and the normal vehicle speed control is started. At this time, since the own vehicle speed V is smaller than the set vehicle speed V_S, the own vehicle 100 is accelerated, the own vehicle speed V increases, and after the own vehicle speed V reaches the set vehicle speed V_S, the acceleration rate of the own vehicle 100 is controlled such that the own vehicle speed V is maintained at the set vehicle speed V_S.

According to this, during the execution of the economy autonomous driving control, when the low efficiency condition C5 is satisfied, the economy autonomous driving control is terminated and the normal vehicle speed control is executed. Therefore, it is possible to prevent the driving energy efficiency from being decreased due to the continued execution of the economy autonomous driving control.

On the other hand, when the vehicle driving assistance device 10 determines “No” at the step S725, the vehicle driving assistance device 10 proceeds with the process to a step S735 to determine whether or not a coasting acceleration condition C6 is satisfied.

The coasting acceleration condition C6 is a condition that the own vehicle 100 travels on a downhill road with a small gradient. In this embodiment, the coasting acceleration condition C6 is a condition that the coasting acceleration rate Gd is greater than zero as shown in the following expression 6 and the absolute value of the coasting acceleration rate Gd is equal to or greater than the coasting acceleration rate threshold G_T as shown in the following expression 7.

$$Gd > 0 \qquad ( 6 )$$

$$\vert Gd \vert \geq G\_T \qquad ( 7 )$$

The coasting acceleration rate threshold G_T is a threshold for determining whether or not the own vehicle 100 travels on the downhill road with a small gradient, and in this embodiment, it is set to a positive value close to “0”. Therefore, the coasting acceleration condition C6 can also be said to be a downhill gradient condition that the road gradient θ is a downhill gradient greater than a predetermined value (or a predetermined downhill gradient threshold θdown).

When the vehicle driving assistance device 10 determines “Yes” at the step S735, the vehicle driving assistance device 10 proceeds with the process to a step S740 to determine whether or not a travelling speed condition C7 is satisfied.

The travelling speed condition C7 is a condition that the own vehicle speed V is smaller than the set vehicle speed V_S as shown in the following expression 8.

$$V < V\_S \qquad ( 8 )$$

When the vehicle driving assistance device 10 determines “Yes” at the step S740, the vehicle driving assistance device 10 proceeds with the process to a step S745 to execute the coasting control, and then proceeds with the process to the step S795 to terminate the process of this routine once.

In this way, in the case where the coasting acceleration condition C6 (or the downhill gradient condition) is satisfied, when the own vehicle speed V is smaller than the set vehicle speed V_S (or a predetermined travelling speed), the economy autonomous driving control is terminated and the coasting control is executed.

That is, while the own vehicle 100 travels on the downhill road with a small gradient, when the own vehicle speed V is smaller than the set vehicle speed V_S, the vehicle driving assistance device 10 executes the coasting control because the own vehicle speed V increases even if the own vehicle 100 coasts.

On the other hand, when the vehicle driving assistance device 10 determines “No” at the step S740, the vehicle driving assistance device 10 proceeds with the process to a step S750 to execute the normal vehicle speed control, and then proceeds with the process to the step S795 to terminate the process of this routine once.

In this way, in the case where the coasting acceleration condition C6 (or the downhill gradient condition) is satisfied, when the own vehicle speed V is equal to or greater than the set vehicle speed V_S (or the predetermined travelling speed), the economy autonomous driving control is terminated and the normal vehicle speed control is executed.

Furthermore, after it is determined “Yes” at the step S740 and the coasting control is started at the step S745, when the own vehicle speed V reaches the set vehicle speed V_S, the vehicle driving control is switched from the coasting control to the normal vehicle speed control.

In this way, when the coasting acceleration condition C6 (or a first condition) is satisfied, the vehicle driving assistance device 10 is configured to suspend the economy autonomous driving control (or the autonomous driving control in the first motion mode) and execute the coasting control (or the autonomous driving control by power control in the first state). In addition, the coasting acceleration condition C6 (or the first condition) is a condition which is likely to be satisfied while the own vehicle 100 travels on the downhill road. Furthermore, the coasting acceleration rate threshold G_T is set to the first coasting acceleration rate threshold G1 when the own vehicle 100 is driven in the hybrid drive mode (or the first drive mode), and is set to the second coasting acceleration rate threshold G2 when the own vehicle 100 is driven in the motor drive mode (or the second drive mode), and the first coasting acceleration rate threshold G1 is a value smaller than the second coasting acceleration rate threshold G2. Therefore, the coasting acceleration condition C6 (or the first condition) is set to a condition which is more likely to be satisfied when the own vehicle 100 is driven autonomously by the economy autonomous driving control in the hybrid drive mode (or the autonomous driving control in the first drive mode) than when the own vehicle 100 is driven autonomously by the economy autonomous driving control in the motor drive mode (or the autonomous driving control in the second drive mode).

While the own vehicle 100 travels on the downhill road, the own vehicle speed V tends to increase even if the own vehicle 100 is driven autonomously by the coasting control, so there is no need to increase the own vehicle speed V by autonomously driving the own vehicle 100 by the optimum powering control. Therefore, while the own vehicle 100 travels on the downhill road, when the own vehicle 100 is driven autonomously by the coasting control, the effect of reducing the consumed energy amount is greater than when the own vehicle 100 is driven autonomously by the optimum powering control. Furthermore, when the own vehicle 100 is driven autonomously by the economy autonomous driving control in the hybrid drive mode, the effect of reducing the consumed energy amount realized by not performing the autonomous driving of the own vehicle 100 by the optimum powering control is greater than when the own vehicle 100 is driven autonomously by the economy autonomous driving control in the motor drive mode.

According to the vehicle driving assistance device 10, the coasting acceleration condition C6 is a condition which is likely to be satisfied while the own vehicle 100 travels on the downhill road. That is, the coasting acceleration condition C6 is a condition under which the economy autonomous driving control is likely to be suspended and the coasting control is likely to be executed while the own vehicle 100 travels on the downhill road. Moreover, the coasting acceleration condition C6 is set to a condition which is less likely to be satisfied when the own vehicle 100 is driven autonomously by the economy autonomous driving control in the motor drive mode than when the own vehicle 100 is driven autonomously by the economy autonomous driving control in the hybrid drive mode. That is, the coasting acceleration condition C6 is a condition under which the economy autonomous driving control is less likely to be suspended and the coasting control is less likely to be executed when the own vehicle 100 is driven autonomously by the economy autonomous driving control in the motor drive mode. Therefore, a great effect of reducing the consumed energy amount can be achieved.

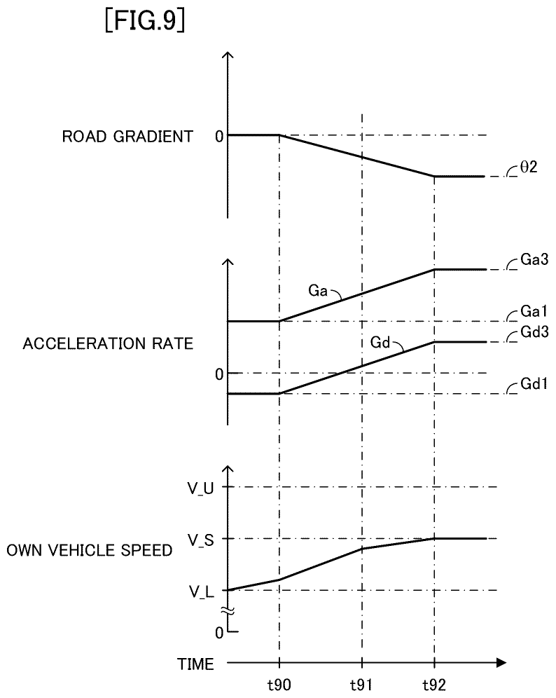

Furthermore, according to the vehicle driving assistance device 10, the own vehicle speed V is controlled as shown in FIG. 9. In the example shown in FIG. 9, the own vehicle 100 travels on a road with the road gradient θ of zero, i.e., a flat road, and the optimum powering control is executed until a time t60. Therefore, the own vehicle speed V gradually increases until the time t60. It should be noted that the optimum powering acceleration rate Ga and the coasting acceleration rate Gd at this time are the first optimum powering acceleration rate Ga1 and the first coasting acceleration rate Gd1, respectively. Furthermore, the first optimum powering acceleration rate Ga1 is a positive value, and the first coasting acceleration rate Gd1 is a negative value.

Then, the own vehicle 100 starts travelling on the downhill road at the time t60. In the example shown in FIG. 9, the road gradient θ continues to decrease from the time t60 to a time t62, and becomes a constant value θ2 after the time t62. Therefore, the optimum powering acceleration rate Ga and the coasting acceleration rate Gd gradually increase from the time t60 to the time t62. In other words, the absolute value of the optimum powering acceleration rate Ga gradually increases. On the other hand, the coasting acceleration rate Gd is negative until a time t61, so its absolute value gradually decreases, and becomes positive after the time t61, so its absolute value gradually increases. Then, after the time t62, the optimum powering acceleration rate Ga and the coasting acceleration rate Gd become constant at a third optimum powering acceleration rate Ga3 and a third coasting acceleration rate Gd3, respectively.

In the example shown in FIG. 9, since the own vehicle 100 travels on the downhill road, and the optimum powering control continues from the time t60 to the time t61, the own vehicle speed V continues to increase at a relatively large increase rate, and at the time t61, the coasting acceleration condition C6 is satisfied. At this time, the own vehicle speed V is smaller than the set vehicle speed V_S, so the economy autonomous driving control is terminated and the coasting control is started. As a result, the increase rate of the own vehicle speed V becomes smaller, but the own vehicle speed V continues to increase.

Then, when the own vehicle speed V reaches the set vehicle speed V_S at the time t62, the coasting control is terminated and the normal vehicle speed control is started. As a result, the acceleration and deceleration of the own vehicle 100 is controlled such that the own vehicle speed V is maintained at the set vehicle speed V_S after the own vehicle speed V reaches the set vehicle speed V_S.

For example, while the own vehicle 100 travels on the downhill road, if the own vehicle 100 coasts, the own vehicle 100 is not decelerated, and the own vehicle 100 is accelerated, and the own vehicle speed V becomes excessively high. As a result, the own vehicle speed V is not maintained within the set vehicle speed range R_V, or the preceding vehicle distance DF is not maintained within the set preceding vehicle distance range R_DF by the economy autonomous driving control. In such a situation, it is not desirable to continue to execute the economy autonomous driving control.

According to the vehicle driving assistance device 10, when the coasting acceleration condition C6 is satisfied, the economy autonomous driving control is terminated. Therefore, it is possible to prevent the economy autonomous driving control from being continued in a situation in which it is not desirable to execute the economy autonomous driving control.

When the vehicle driving assistance device 10 determines “No” at the step S735, the vehicle driving assistance device 10 proceeds with the process to a step S505 of the routine shown in FIG. 5 via a step S755 to execute the processes as described above, and then terminates the process of this routine once.

When the vehicle driving assistance device 10 determines “No” at the step S715, the vehicle driving assistance device 10 proceeds with the process to a step S760 to executes an engine continued operation control, and then proceeds with the process to the step S795 to terminate the process of this routine once. The engine continued operation control is a mode in which the own vehicle 100 is driven in an engine drive mode. The engine drive mode is a mode in which the internal combustion engine 21 continues to be operated.

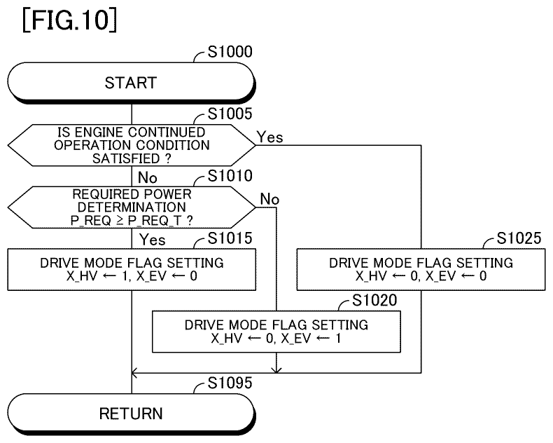

Furthermore, the vehicle driving assistance device 10 is configured to execute a routine shown in FIG. 10 at a predetermined calculation cycle. Therefore, when a predetermined timing arrives, the vehicle driving assistance device 10 starts a process from a step S1000 of the routine shown in FIG. 10, and proceeds with the process to a step S1005 to determine whether or not an engine continued operation condition C8 is satisfied.

The engine continued operation condition C8 is a condition that is satisfied when it is necessary to continue operating the internal combustion engine 21. For example, when the charge amount of the electric power storage device 41 becomes less than a predetermined amount (or a predetermined charge amount) and it is necessary to operate the internal combustion engine 21 to charge the electric power storage device 41, it becomes necessary to continue operating the internal combustion engine 21.

When the vehicle driving assistance device 10 determines “No” at the step S1005, the vehicle driving assistance device 10 proceeds with the process to a step S1010 to determine whether or not the required power P_REQ is equal to or greater than a predetermined required power P_REQ_T.

When the vehicle driving assistance device 10 determines “Yes” at the step S1010, the vehicle driving assistance device 10 proceeds with the process to a step S1015 to set the value of the hybrid drive mode flag X_HV to “1” and set the value of the motor drive mode flag X_EV to “0”, and then the vehicle driving assistance device 10 proceeds with the process to a step S1095 to terminate the process of this routine once. In this case, the own vehicle 100 is driven in the hybrid drive mode.

On the other hand, when the vehicle driving assistance device 10 determines “No” at the step S1010, the vehicle driving assistance device 10 proceeds with the process to a step S1020 to set the value of the hybrid drive mode flag X_HV to “0” and set the value of the motor drive mode flag X_EV to “1”, and then the vehicle driving assistance device 10 proceeds with the process to a step S1095 to terminate the process of this routine once. In this case, the own vehicle 100 is driven in the motor drive mode.

When the vehicle driving assistance device 10 determines “Yes” at the step S1005, the vehicle driving assistance device 10 proceeds with the process to a step S1025 to set the value of the hybrid drive mode flag X_HV to “0”, and set the value of the motor drive mode flag X_EV to “0”, and then proceeds with the process to the step S1095 to terminate the process of this routine once. In this case, the own vehicle 100 is driven in the engine drive mode.

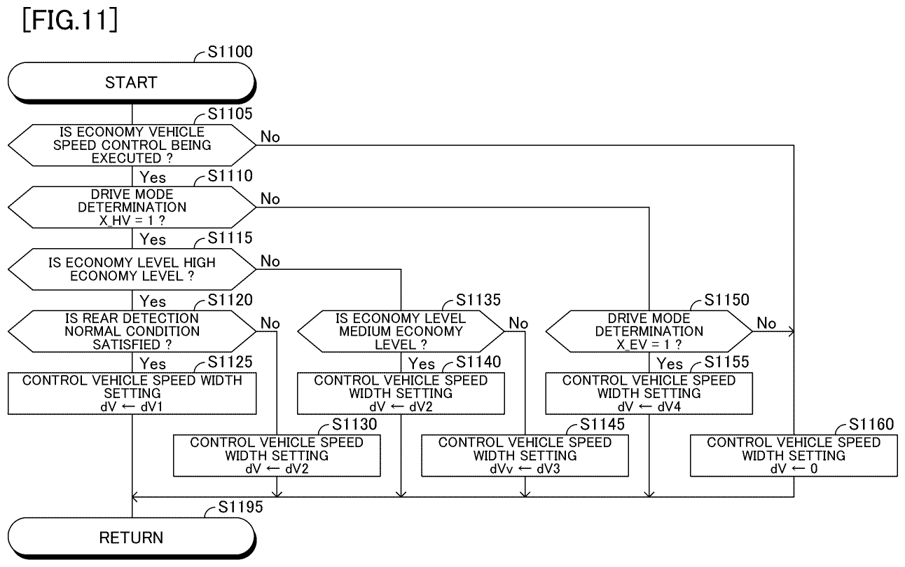

Furthermore, the vehicle driving assistance device 10 is configured to execute a routine shown in FIG. 11 at a predetermined calculation cycle. Therefore, when a predetermined timing arrives, the vehicle driving assistance device 10 starts a process from a step S1100 of the routine shown in FIG. 11, and proceeds with the process to a step S1105 to determine whether or not the economy vehicle speed control is executed.

When the vehicle driving assistance device 10 determines “Yes” at the step S1105, the vehicle driving assistance device 10 proceeds with the process to a step S1110 to determine whether or not the value of the hybrid drive mode flag X_HV is “1”. That is, the vehicle driving assistance device 10 determines whether or not the own vehicle 100 is currently driven in the hybrid drive mode.

When the vehicle driving assistance device 10 determines “Yes” at the step S1110, the vehicle driving assistance device 10 proceeds with the process to a step S1115 to determine whether or not an economy level LV is a high economy level LV_H.

As shown in FIG. 1, the own vehicle 100 is equipped with an economy level setting operator 73 such as an economy level setting button. The economy level setting operator 73 is electrically connected to the ECU 90. The driver can set the economy level LV (or an energy efficiency level) to any one of the high economy level LV_H, a medium economy level LV_M, and a low economy level LV_L by operating the economy level setting operator 73.

The economy level LV is a level requested by the driver as a level (or an energy efficiency improvement level) for improving the energy efficiency of the power device 20. In the case where the economy level LV is set to the high economy level LV_H, a maximum energy efficiency improvement level is requested by the driver, in the case where the economy level LV is set to the low economy level LV_L, a minimum energy efficiency improvement level is requested by the driver, and in the case where the economy level LV is set to the medium economy level LV_M, an energy efficiency improvement level which is smaller than the maximum energy efficiency improvement level but greater than the minimum energy efficiency improvement level is requested by the driver.

As will be described later, the vehicle driving assistance device 10 is configured to set the set vehicle speed range R_V depending on the economy level LV. In general, the vehicle driving assistance device 10 sets the set vehicle speed range R_V and the set preceding vehicle distance range R_DF to wider ranges as the economy level LV becomes higher. In particular, in this embodiment, the set vehicle speed range R_V and the set preceding vehicle distance range R_DF can be changed by a setting operation by the driver of the own vehicle 100 when the own vehicle 100 is driven in the hybrid drive mode.

When the vehicle driving assistance device 10 determines “Yes” at the step S1115, the vehicle driving assistance device 10 proceeds with the process to a step S1120 to determine whether or not a rear detection normal condition C9 is satisfied.

The rear detection normal condition C9 is satisfied when the rear information detection device 52 functions normally and can normally detect the rear detection information IR used to detect the following vehicle 300. Therefore, the rear detection normal condition C9 is not satisfied when the rear detection information IR used to detect the following vehicle 300 cannot be detected due to an abnormality in the rear information detection device 52 or the like. It should be noted that the rear detection normal condition C9 may be a condition which is not satisfied when the rear information detection device 52 is not installed in the own vehicle 100.

When the vehicle driving assistance device 10 determines “Yes” at the step S1120, the vehicle driving assistance device 10 proceeds with the process to a step S1125 to set the control vehicle speed width dV to a first vehicle speed width dV1, and then proceeds with the process to a step S1195 to terminate the process of this routine once. The first vehicle speed width dV1 is set to a relatively large value which is greater than zero.

On the other hand, when the vehicle driving assistance device 10 determines “No” at the step S1120, the vehicle driving assistance device 10 proceeds with the process to a step S1130 to set the control vehicle speed width dV to a second vehicle speed width dV2, and then proceeds with the process to the step S1195 to terminate the process of this routine once. The second vehicle speed width dV2 is set to a value greater than zero and smaller than the first vehicle speed width dV1.

In this way, during the execution of the economy vehicle speed control (or the vehicle speed increase/decrease control), when the rear detection normal condition C9 is not satisfied (or when a control range change condition that there is an abnormality in the following vehicle detection device which detects the following vehicle 300, is satisfied), the vehicle driving assistance device 10 is configured to set the set vehicle speed range R_V to a narrower range than when the rear detection normal condition C9 is satisfied (or when the control range change condition is not satisfied).

In other words, in the case where the own vehicle 100 is driven autonomously by the economy vehicle speed control in the hybrid drive mode (or the autonomous driving control in the first drive mode), when an abnormality occurs in the rear information detection device 52 (or the following vehicle detection device which detects the following vehicle 300), the vehicle driving assistance device 10 is configured to set the set vehicle speed range R_V (or the set control range) to a narrower range than when the rear information detection device 52 is normal.

In case where the own vehicle 100 is driven autonomously by the economy vehicle speed control, when the following vehicle 300 is present, if the own vehicle speed V increases or decreases excessively, the following vehicle 300 increases or decreases its vehicle speed significantly, which may hinder the smooth traffic of the surrounding vehicles including the following vehicle 300. Therefore, in order to maintain the smooth traffic of the surrounding vehicles, in the case where the own vehicle 100 is driven autonomously by the economy vehicle speed control, when the following vehicle 300 is present, it is desirable to autonomously drive the own vehicle 100 by the economy vehicle speed control taking into account the presence of the following vehicle 300. However, when the following vehicle 300 cannot be detected due to an abnormality occurring in the rear information detection device 52, the economy vehicle speed control cannot be executed taking into account the presence of the following vehicle 300, and therefore the own vehicle 100 cannot be driven autonomously by the economy vehicle speed control such that the smooth traffic of the surrounding vehicles is maintained.

According to the vehicle driving assistance device 10, when an abnormality occurs in the rear information detection device 52, the set vehicle speed range R_V is set to a narrower range than when the rear information detection device 52 is normal. This makes it possible to prevent the own vehicle speed V from increasing or decreasing excessively. Therefore, even when the following vehicle 300 cannot be detected, the own vehicle 100 can be driven autonomously by the economy vehicle speed control without hindering the smooth traffic of the surrounding vehicles.

When the vehicle driving assistance device 10 determines “No” at the step S1115, the vehicle driving assistance device 10 proceeds with the process to a step S1135 to determine whether or not the economy level LV is the medium economy level LV_M.

When the vehicle driving assistance device 10 determines “Yes” at the step S1135, the vehicle driving assistance device 10 proceeds with the process to a step S1140 to set the control vehicle speed width dV to the second vehicle speed width dV2, and then proceeds with the process to the step S1195 to terminate the process of this routine once.

On the other hand, when the vehicle driving assistance device 10 determines “No” at the step S1135, the vehicle driving assistance device 10 proceeds with the process to a step S1145 to set the control vehicle speed width dV to a third vehicle speed width dV3, and then proceeds with the process to the step S1195 to terminate the process of this routine once. The third vehicle speed width dV3 is set to a value greater than zero and less than the second vehicle speed width dV2.

When the vehicle driving assistance device 10 determines “No” at the step S1110, the vehicle driving assistance device 10 proceeds with the process to a step S1150 to determine whether or not the value of the motor drive mode flag X_EV is “1”.

When the vehicle driving assistance device 10 determines “Yes” at the step S1150, the vehicle driving assistance device 10 proceeds with the process to a step S1155 to set the control vehicle speed width dV to a fourth vehicle speed width dV4, and then proceeds with the process to the step S1195 to terminate the process of this routine once. The fourth vehicle speed width dV4 is set to a value greater than zero and less than the third vehicle speed width dV3.

In this way, the vehicle driving assistance device 10 is configured to be able to execute the economy vehicle speed control (or the vehicle speed increase/decrease control) in the hybrid drive mode (or the first drive mode) in which both the internal combustion engine 21 and the electric motor 22 or only the internal combustion engine 21 are operated to apply the power to the own vehicle 100 and drive the own vehicle 100, and in the motor drive mode (or the second drive mode) in which only the electric motor 22 is operated to apply the power to the own vehicle 100 and drive the own vehicle 100.

In addition, when the economy vehicle speed control (or the vehicle speed increase/decrease control) is executed in the motor drive mode (or the second drive mode), the set vehicle speed range R_V is set to a narrower range than when the economy vehicle speed control (or the vehicle speed increase/decrease control) is executed in the hybrid drive mode (or the first drive mode).

In addition, the condition for reducing the control vehicle speed width dV includes the condition that the economy vehicle speed control (or the vehicle speed increase/decrease control) is executed in the hybrid drive mode (or the first drive mode), and while the economy vehicle speed control is executed in the motor drive mode (or the second drive mode), the vehicle driving assistance device 10 is configured not to change the set vehicle speed range R_V even if the rear detection normal condition C9 is not satisfied (or even if the control range change condition is satisfied).

In other words, the vehicle driving assistance device 10 is configured not to change the control vehicle speed width dV (or the set control range) even if an abnormality occurs in the rear information detection device 52 (or the following vehicle detection device which detects the following vehicle 300) during the execution of the economy vehicle speed control in the motor drive mode (or the autonomous driving control in the second drive mode).

According to the vehicle driving assistance device 10, when the own vehicle 100 is driven autonomously by the economy vehicle speed control in the motor drive mode, the set vehicle speed range R_V is set to a relatively narrow range. Therefore, even in a situation where the following vehicle 300 cannot be detected due to an abnormality occurring in the rear information detection device 52, the own vehicle speed V does not increase or decrease excessively even if the autonomous driving of the own vehicle 100 by the economy vehicle speed control continues without changing the set vehicle speed range R_V, and therefore the following vehicle 300 does not increase or decrease its vehicle speed significantly. Thus, there is little possibility of hindering the smooth traffic of the surrounding vehicles. Therefore, the own vehicle 100 can be driven autonomously by the economy vehicle speed control such that the smooth traffic of the surrounding vehicles is maintained without changing the set vehicle speed range R_V.

Furthermore, during the execution of the economy vehicle speed control, when the drive mode is the hybrid drive mode (or the first drive mode in which the power other than the power generated by the electric power of the electric power storage device 41 can be used), the vehicle driving assistance device 10 is configured to set the control vehicle speed width dV (or the set control range) to a wider range than when the drive mode is the motor drive mode (or the second drive mode in which only the power generated by the electric power of the electric power storage device 41 is used).

Furthermore, in the case where the rear detection normal condition C9 is satisfied (or the control range change condition is not satisfied) while the vehicle driving assistance device 10 executes the economy vehicle speed control (or the vehicle speed increase/decrease control) while selectively executing the coasting control (or the power control in the first state) and the optimum powering control (or the power control in the second state), when the own vehicle 100 is driven autonomously by the economy vehicle speed control in the hybrid drive mode (or the vehicle speed increase/decrease control in the first drive mode), the vehicle driving assistance device 10 is configured to set the set vehicle speed range R_V to a wider range than when the own vehicle 100 is driven autonomously in the second drive mode by the economy vehicle speed control in the motor drive mode (or the vehicle speed increase/decrease control in the second drive mode).

In the case where the autonomous driving control is to be executed, that is, in the case where the own vehicle 100 is to be driven autonomously by the economy vehicle speed control while the coasting control and the optimum acceleration control are selectively executed, when the own vehicle 100 is to be autonomously driven in the hybrid drive mode, if the set vehicle speed range R_V is set to a wide range, the effect of reducing the consumed energy amount is generally greater. However, in the case where the own vehicle 100 is to be autonomously driven in the motor drive mode, if the set vehicle speed range R_V is set to a wide range, the effect of reducing the consumed energy amount is not so great, but the risk of hindering the smooth traffic of the surrounding vehicles increases.

According to the vehicle driving assistance device 10, in the case where the own vehicle 100 is driven autonomously by the economy vehicle speed control while the coasting control and the optimum powering control are selectively executed, while the rear detection normal condition C9 is satisfied, when the drive mode is the hybrid drive mode, the set vehicle speed range R_V is set to a wider range than when the drive mode is the motor drive mode. Therefore, it is possible to achieve a certain effect of reducing the consumed energy amount depending on the drive mode while preventing the hindrance of the smooth traffic of the surrounding vehicles.

On the other hand, when the vehicle driving assistance device 10 determines “No” at the step S1150, the vehicle driving assistance device 10 proceeds with the process to a step S1160 to set the control vehicle speed width dV to zero, and then proceeds with the process to the step S1195 to terminate the process of this routine once. In this case, since the drive mode is neither the hybrid drive mode nor the motor drive mode, as described above, the engine continued operation control is executed.

Also, when the vehicle driving assistance device 10 determines “No” at the step S1105, the vehicle driving assistance device 10 proceeds with the process to the step S1160 to set the control vehicle speed width dV to zero, and then proceeds with the process to the step S1195 to terminate the process of this routine once. In this case, if the preceding vehicle 200 is not present, the normal vehicle speed control is executed.

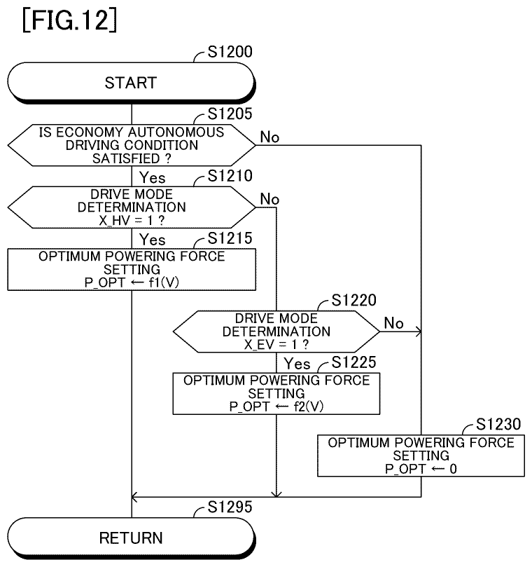

Furthermore, the vehicle driving assistance device 10 executes a routine shown in FIG. 12 at a predetermined calculation cycle. Therefore, when a predetermined timing arrives, the vehicle driving assistance device 10 starts a process from a step S1200 of the routine shown in FIG. 12, and proceeds with the process to a step S1205 to determine whether or not the economy autonomous driving condition C3 is satisfied. That is, the vehicle driving assistance device 10 determines whether or not the economy autonomous driving control is executed.

When the vehicle driving assistance device 10 determines “Yes” at the step S1205, the vehicle driving assistance device 10 proceeds with the process to a step S1210 to determine whether or not the value of the hybrid drive mode flag X_HV is “1”. That is, the vehicle driving assistance device 10 determines whether or not the drive mode is the hybrid drive mode.

When the vehicle driving assistance device 10 determines “Yes” at the step S1210, the vehicle driving assistance device 10 proceeds with the process to a step S1215 to set the optimum powering force P_OPT based on the own vehicle speed V, and then proceeds with the process to a step S1295 to terminate the process of this routine once. In this case, the economy autonomous driving control is executed based on the optimum powering force P_OPT set at the step S1215.

On the other hand, when the vehicle driving assistance device 10 determines “No” at the step S1210, the vehicle driving assistance device 10 proceeds with the process to a step S1220 to determine whether or not the value of the motor drive mode flag X_EV is “1”. That is, the vehicle driving assistance device 10 determines whether or not the drive mode is the motor drive mode.

When the vehicle driving assistance device 10 determines “Yes” at the step S1220, the vehicle driving assistance device 10 proceeds with the process to a step S1225 to set the optimum powering force P_OPT based on the own vehicle speed V, and then proceeds with the process to the step S1295 to terminate the process of this routine once. In this case, the economy autonomous driving control is executed based on the optimum powering force P_OPT set at the step S1225.

On the other hand, when the vehicle driving assistance device 10 determines “No” at the step S1220, the vehicle driving assistance device 10 proceeds with the process to a step S1230 to set the optimum powering force P_OPT to zero, and then proceeds with the process to the step S1295 to terminate the process of this routine once. In this case, since the drive mode is neither the hybrid drive mode nor the motor drive mode, the engine continued operation control is executed as described above.

Also, when the vehicle driving assistance device 10 determines “No” at the step S1205, the vehicle driving assistance device 10 proceeds with the process to the step S1230 to set the optimum powering force P_OPT to zero, and then proceeds with the process to the step S1295 to terminate the process of this routine once. In this case, since the economy autonomous driving condition C3 is not satisfied, the normal autonomous driving control is executed.

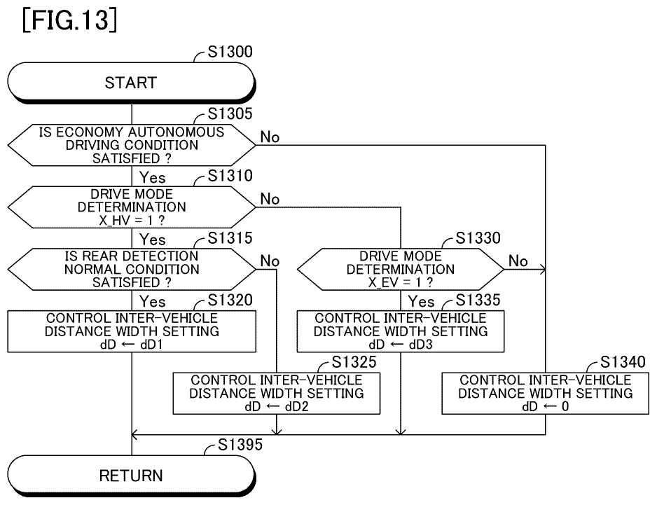

Furthermore, the vehicle driving assistance device 10 executes a routine shown in FIG. 13 at a predetermined calculation cycle. Therefore, when a predetermined timing arrives, the vehicle driving assistance device 10 starts a process from a step S1300 of the routine shown in FIG. 13, and proceeds with the process to a step S1305 to determine whether or not the economy autonomous driving condition C3 is satisfied. That is, the vehicle driving assistance device 10 determines whether or not the economy autonomous driving control is currently executed.

When the vehicle driving assistance device 10 determines “Yes” at the step S1305, the vehicle driving assistance device 10 proceeds with the process to a step S1310 to determine whether or not the value of the hybrid drive mode flag X_HV is “1”. That is, the vehicle driving assistance device 10 determines whether or not the own vehicle 100 is currently driven in the hybrid drive mode.

When the vehicle driving assistance device 10 determines “Yes” at the step S1310, the vehicle driving assistance device 10 proceeds with the process to a step S1315 to determine whether or not the rear detection normal condition C9 is satisfied.

When the vehicle driving assistance device 10 determines “Yes” at the step S1315, the vehicle driving assistance device 10 proceeds with the process to a step S1320 to set the control inter-vehicle distance width dD to a first inter-vehicle distance width dD1, and then proceeds with the process to a step S1395 to terminate the process of this routine once. The first inter-vehicle distance width dD1 is set to a relatively large value which is greater than zero. In this case, when the economy inter-vehicle distance control is to be executed, the economy inter-vehicle distance control is executed based on the set vehicle speed range R_V which is set based on the first inter-vehicle distance width dD1.

On the other hand, when the vehicle driving assistance device 10 determines “No” at the step S1315, the vehicle driving assistance device 10 proceeds with the process to a step S1325 to set the control inter-vehicle distance width dD to a second inter-vehicle distance width dD2, and then proceeds with the process to the step S1195 to terminate the process of this routine once. The second inter-vehicle distance width dD2 is set to a value greater than zero and smaller than the first inter-vehicle distance width dD1. In this case, when the economy inter-vehicle distance control is to be executed, the economy inter-vehicle distance control is executed based on the set vehicle speed range R_V which is set based on the second inter-vehicle distance width dD2 which is smaller than the first inter-vehicle distance width dD1.

In this way, during the execution of the economy inter-vehicle distance control (or the inter-vehicle distance increase/decrease control), when the rear detection normal condition C9 is not satisfied (or when the control range change condition that there is an abnormality in the following vehicle detection device which detects the following vehicle 300, is satisfied), the vehicle driving assistance device 10 is configured to set the set preceding vehicle distance range R_DF to a narrower range than when the rear detection normal condition C9 is satisfied (or when the control range change condition is not satisfied).

In other words, in the case where the own vehicle 100 is driven autonomously by the economy inter-vehicle distance control in the hybrid drive mode (or the autonomous driving control in the first drive mode), when an abnormality occurs in the rear information detection device 52 (or the following vehicle detection device which detects the following vehicle 300), the vehicle driving assistance device 10 is configured to set the set preceding vehicle distance range R_DF (or the set control range) to a narrower range than when the rear information detection device 52 is normal.

In the case where the own vehicle 100 is driven autonomously by the economy inter-vehicle distance control, while the following vehicle 300 is present, if the preceding vehicle distance DF increases or decreases excessively, the following vehicle 300 increases or decreases its vehicle speed significantly, which may hinder the smooth traffic of the surrounding vehicles including the following vehicle 300. Therefore, in order to maintain the smooth traffic of the surrounding vehicles, in the case where the own vehicle 100 is driven autonomously by the economy inter-vehicle distance control, while the following vehicle 300 is present, it is desirable to autonomously drive the own vehicle 100 by the economy inter-vehicle distance control taking into account the presence of the following vehicle 300. However, when the following vehicle 300 cannot be detected due to an abnormality occurring in the rear information detection device 52, the economy inter-vehicle distance control cannot be executed taking into account the presence of the following vehicle 300, and therefore the own vehicle 100 cannot be driven autonomously by the economy inter-vehicle distance control such that the smooth traffic of the surrounding vehicles is maintained.

According to the vehicle driving assistance device 10, when an abnormality occurs in the rear information detection device 52, the set preceding vehicle distance range R_DF is set to a narrower range than when the rear information detection device 52 is normal. This makes it possible to prevent the preceding vehicle distance DF from increasing or decreasing excessively. Therefore, even when an abnormality occurs in the rear information detection device 52, the own vehicle 100 can be driven autonomously by the economy inter-vehicle distance control without hindering the smooth traffic of the surrounding vehicles.

When the vehicle driving assistance device 10 determines “No” at the step S1310, the vehicle driving assistance device 10 proceeds with the process to a step S1330 to determine whether or not the value of the motor drive mode flag X_EV is “1”. That is, the vehicle driving assistance device 10 determines whether or not the own vehicle 100 is currently driven in the motor drive mode.

When the vehicle driving assistance device 10 determines “Yes” at the step S1330, the vehicle driving assistance device 10 proceeds with the process to a step S1335 to set the control inter-vehicle distance width dD to a third inter-vehicle distance width dD3, and then proceeds with the process to the step S1395 to terminate the process of this routine once. The third inter-vehicle distance width dD3 is set to a value greater than zero and smaller than the second inter-vehicle distance width dD2. In this case, when the economy inter-vehicle distance control is to be executed, the economy inter-vehicle distance control is executed based on the set vehicle speed range R_V which is set based on the third inter-vehicle distance width dD3 which is smaller than the second inter-vehicle distance width dD2.

In this way, the vehicle driving assistance device 10 is configured to be able to execute the economy inter-vehicle distance control (or the inter-vehicle distance increase/decrease control) in the hybrid drive mode (or the first drive mode) in which both the internal combustion engine 21 and the electric motor 22 or only the internal combustion engine 21 are operated to apply the power to the own vehicle 100 and drive the own vehicle 100, and in the motor drive mode (or the second drive mode) in which only the electric motor 22 is operated to apply the power to the own vehicle 100 and drive the own vehicle 100.

In addition, when the economy inter-vehicle distance control (or the inter-vehicle distance increase/decrease control) is executed in the motor drive mode (or the second drive mode), the set preceding vehicle distance range R_DF is set to a narrower range than when the economy inter-vehicle distance control (or the inter-vehicle distance increase/decrease control) is executed in the hybrid drive mode (or the first drive mode).

In addition, the condition for reducing the control inter-vehicle distance width dD includes the condition that the economy inter-vehicle distance control (or the inter-vehicle distance increase/decrease control) is executed in the hybrid drive mode (or the first drive mode), and while the vehicle driving assistance device 10 executes the economy inter-vehicle distance control (or the inter-vehicle distance increase/decrease control) in the motor drive mode (or the second drive mode), the vehicle driving assistance device 10 is configured not to change the set preceding vehicle distance range R_DF (or the set inter-vehicle distance range) even if the rear detection normal condition C9 is not satisfied (or even if the control range change condition is satisfied).

In other words, the vehicle driving assistance device 10 is configured not to change the control inter-vehicle distance width dD (or the set control range) even if an abnormality occurs in the rear information detection device 52 (or the following vehicle detection device which detects the following vehicle 300) during the execution of the economy inter-vehicle distance control in the motor drive mode (or the second drive mode).

According to the vehicle driving assistance device 10, when the own vehicle 100 is driven autonomously by the economy inter-vehicle distance control in the motor drive mode, the set preceding vehicle distance range R_DF is set to a relatively narrow range. Therefore, even in a situation where the following vehicle 300 cannot be detected due to an abnormality occurring in the rear information detection device 52, the preceding vehicle distance DF does not increase or decrease excessively even if the autonomous driving of the own vehicle 100 by the economy inter-vehicle distance control continues without changing the set preceding vehicle distance range R_DF, and therefore the following vehicle 300 does not increase or decrease its vehicle speed significantly. Thus, there is little possibility of hindering the smooth traffic of the surrounding vehicles. Therefore, the own vehicle 100 can be driven autonomously by the economy inter-vehicle distance control such that the smooth traffic of the surrounding vehicles is maintained without changing the set preceding vehicle distance range R_DF.

Furthermore, during the execution of the economy inter-vehicle distance control, when the drive mode is the hybrid drive mode (or the first drive mode in which the power other than the power generated by the electric power of the electric power storage device 41 can be used), the vehicle driving assistance device 10 is configured to set the control inter-vehicle distance width dD (or the set control range) to a wider range than when the drive mode is the motor drive mode (or the second drive mode in which only the power generated by the electric power of the electric power storage device 41 is used).

Furthermore, in the case where the vehicle driving assistance device 10 executes the economy inter-vehicle distance control (or the inter-vehicle distance increasing/decreasing control) while selectively executing the coasting control (or the power control in the first state) and the optimum powering control (or the power control in the second state), while the rear detection normal condition C9 is satisfied (or the control range change condition is not satisfied), when the own vehicle 100 is driven autonomously by the economy inter-vehicle distance control in the hybrid drive mode (the inter-vehicle distance increasing/decreasing control in the first drive mode), the vehicle driving assistance device 10 is configured to set the set preceding vehicle distance range R_DF (or the set inter-vehicle distance range) to a wider range than when the own vehicle 100 is driven autonomously in the second drive mode by the economy inter-vehicle distance control in the motor drive mode (or the inter-vehicle distance increasing/decreasing control in the second drive mode).

In the case where the autonomous driving control is executed, that is, in the case where the own vehicle 100 is driven autonomously by the economy inter-vehicle distance control while the coasting control and the optimum acceleration control are selectively executed, when the own vehicle 100 is to be driven autonomously in the hybrid drive mode, if the set preceding vehicle distance range R_DF is set to a wide range, the effect of reducing the consumed energy amount is generally greater. However, when the own vehicle 100 is driven autonomously in the motor drive mode, if the set preceding vehicle distance range R_DF is set to a wide range, the effect of reducing the consumed energy amount is not so great, but the risk of hindering the smooth traffic of the surrounding vehicles increases.

According to the vehicle driving assistance device 10, in the case where the own vehicle 100 is driven autonomously by the economy inter-vehicle distance control while the coasting control and the optimum powering control are selectively executed, while the rear detection normal condition C9 is satisfied, when the drive mode is the hybrid drive mode, the set preceding vehicle distance range R_DF is set to a wider range than when the drive mode is the motor drive mode. Therefore, it is possible to achieve a certain effect of reducing the consumed energy amount depending on the drive mode while preventing the hindrance of the smooth traffic of the surrounding vehicles.

On the other hand, when the vehicle driving assistance device 10 determines “No” at the step S1330, the vehicle driving assistance device 10 proceeds with the process to a step S1340 to set the control inter-vehicle distance width dD to zero, and then proceeds with the process to the step S1395 to terminate the process of this routine once. In this case, since the drive mode is neither the hybrid drive mode nor the motor drive mode, the engine continued operation control is executed as described above.

Also, when the vehicle driving assistance device 10 determines “No” at the step S1305, the vehicle driving assistance device 10 proceeds with the process to the step S1340 to set the control inter-vehicle distance width dD to zero, and then proceeds with the process to the step S1195 to terminate the process of this routine once.

The present invention is not limited to the above embodiments, and various modified examples can be adopted within the scope of the present invention.

For example, during the execution of the economy inter-vehicle distance control, the vehicle driving assistance device 10 may be configured to execute the economy vehicle speed control when the own vehicle speed V increases and reaches the upper limit vehicle speed V_U described below.

Also, as shown in FIG. 3A, while the following vehicle 300 is present, the vehicle driving assistance device 10 may be configured to execute the optimum powering control to accelerate the own vehicle 100 when the following vehicle distance DR becomes equal to or less than a predetermined following vehicle distance DR_T during the execution of the economy inter-vehicle distance control, even if the preceding vehicle distance DF is smaller than the upper limit preceding vehicle distance DF_U. In this case, after starting the optimum powering control, the vehicle driving assistance device 10 continues the optimum powering control until the preceding vehicle distance DF reaches the lower limit preceding vehicle distance DF_L, even if the following vehicle distance DR becomes greater than the predetermined following vehicle distance DR_T.

Furthermore, while the following vehicle 300 is present, the vehicle driving assistance device 10 may be configured to determine the timing to start the optimum powering control such that the own vehicle 100 does not get too close to the following vehicle 300 during the execution of the economy inter-vehicle distance control, taking into consideration the difference between the own vehicle speed V and a travelling speed of the following vehicle 300.

It should be noted that as shown in FIG. 3B, while the following vehicle 300 which is another vehicle around the own vehicle 100 is present, the vehicle driving assistance device 10 may be configured to execute the optimum powering control to accelerate the own vehicle 100 when the distance (or the following vehicle distance DR) between the own vehicle 100 and the following vehicle 300 becomes equal to or less than a predetermined distance (or the predetermined following vehicle distance DR_T) during the execution of the economy inter-vehicle distance control, even if the own vehicle speed V is greater than the lower limit vehicle speed V_L. In this case, after starting the optimum powering control, the vehicle driving assistance device 10 continues the optimum powering control until the own vehicle speed V reaches the upper limit vehicle speed V_U, even if the following vehicle distance DR becomes greater than the predetermined following vehicle distance DR_T.

Furthermore, while the following vehicle 300 is present, the vehicle driving assistance device 10 may be configured to determine the timing to start the optimum powering control such that the own vehicle 100 does not get too close to the following vehicle 300 during the execution of the economy vehicle speed control, taking into consideration the difference between the own vehicle speed V and the travelling speed of the following vehicle 300.

### REFERENCE SIGNS LIST

10 . . . . Vehicle driving assistance device, 20 . . . . Power device, 41 . . . . Electric power storage device, 52 . . . . Rear information detection device, 90 . . . . ECU, 100 . . . . Own vehicle, 200 . . . . Preceding vehicle, 300 . . . . Following vehicle

1. A vehicle driving assistance device, comprising an electronic control unit configured to execute an autonomous driving control of autonomously driving an own vehicle in a first motion mode in which a control value of the own vehicle is increased or decreased within a set control range by selectively executing a power control in a first state in which a power generation loss in a power device or a power transmission loss from the power device to driving wheels is reduced, and a power control in a second state in which the power device is mechanically or electrically connected to the driving wheels and power is applied to the driving wheels,
wherein the electronic control unit is configured to set the set control range to a wider range when a drive mode is a first drive mode in which the power other than the power generated by electric power of a power storage device can be used than when the drive mode is a second drive mode in which only power generated by the electric power is used during the execution of the autonomous driving control in the first motion mode.

2. The vehicle driving assistance device according to claim 1, wherein the set control range is changeable by a setting operation by a driver of the own vehicle while the own vehicle is driven autonomously by the autonomous driving control in the first drive mode.

3. The vehicle driving assistance device according to claim 1, wherein while the own vehicle is driven autonomously by the autonomous driving control in the first drive mode, when an abnormality occurs in a following vehicle detection device which detects a following vehicle, the electronic control unit is configured to set the set control range to a narrower range than when the following vehicle detection device is normal.

4. The vehicle driving assistance device according to claim 3,
wherein the electronic control unit is configured to be able to execute the autonomous driving control in a second motion mode in which the control value is maintained at a set control value, and
wherein during the execution of the autonomous driving control in the first motion mode, the electronic control unit is configured to switch a mode of the autonomous driving control from the first motion mode to the second motion mode when a motion mode switching condition that the following vehicle detection device is normal, the following vehicle is detected, and a distance between the following vehicle and the own vehicle is equal to or less than a predetermined distance, or a time required for the own vehicle to travel the distance between the following vehicle and the own vehicle is equal to or less than a predetermined time, is satisfied.

5. The vehicle driving assistance device according to claim 3,
wherein when the autonomous driving control is executed in the second drive mode, the set control range is set to a narrower range than when the autonomous driving control is executed in the first drive mode, and
wherein during the execution of the autonomous driving control in the second drive mode, the electronic control unit is configured not to change the set control range even when an abnormality occurs in the following vehicle detection device.

6. The vehicle driving assistance device according to claim 1,
wherein the electronic control unit is configured to suspend the autonomous driving control in the first motion mode and execute the autonomous driving control by the power control in the first state when a first condition is satisfied, and
wherein the first condition is set to a condition which is likely to be satisfied while the own vehicle travels on a downhill road, and is more likely to be satisfied when the own vehicle is driven autonomously by the autonomous driving control in the first drive mode than when the own vehicle is driven autonomously by the autonomous driving control in the second drive mode.

7. The vehicle driving assistance device according to claim 1,
wherein the electronic control unit is configured to be able to execute the autonomous driving control in a constant speed mode in which a vehicle speed of the own vehicle is maintained at a set vehicle speed,
wherein the electronic control unit is configured to suspend the autonomous driving control in the first motion mode and execute the autonomous driving control in the constant speed mode when a second condition is satisfied, and
wherein the second condition is a condition which is likely to be satisfied while the own vehicle travels on an uphill road or while the own vehicle travels at a vehicle speed equal to or higher than a predetermined vehicle speed, and is more likely to be satisfied when the own vehicle is driven autonomously by the autonomous driving control in the first drive mode than when the own vehicle is driven autonomously by the autonomous driving control in the second drive mode.

8. A vehicle driving assistance method for executing an autonomous driving control of autonomously driving an own vehicle in a first motion mode in which a control value of the own vehicle is increased or decreased within a set control range by selectively executing a power control in a first state in which a power generation loss in a power device or a power transmission loss from the power device to driving wheels is reduced, and a power control in a second state in which the power device is mechanically or electrically connected to the driving wheels and power is applied to the driving wheels,
wherein the vehicle driving assistance method comprises a step of setting the set control range to a wider range when a drive mode is a first drive mode in which the power other than the power generated by electric power of a power storage device can be used than when the drive mode is a second drive mode in which only power generated by the electric power is used during the execution of the autonomous driving control in the first motion mode.

9. A computer-readable storage medium storing a vehicle driving assistance program which executes an autonomous driving control of autonomously driving an own vehicle in a first motion mode in which a control value of the own vehicle is increased or decreased within a set control range by selectively executing a power control in a first state in which a power generation loss in a power device or a power transmission loss from the power device to driving wheels is reduced, and a power control in a second state in which the power device is mechanically or electrically connected to the driving wheels and power is applied to the driving wheels,
wherein the vehicle driving assistance program is configured to set the set control range to a wider range when a drive mode is a first drive mode in which the power other than the power generated by electric power of a power storage device can be used than when the drive mode is a second drive mode in which only power generated by the electric power is used during the execution of the autonomous driving control in the first motion mode.
